(19) United States
(12) Patent Application Publication
(10) Pub. No.: US 2026/0349260 A1
(43) Pub. Date: Nov. 5, 2026

(54) OPTICAL STRUCTURES FOR ENHANCED DISPLAY AND PHOTONIC SYSTEMS

(71) Applicant: Meta Platforms Technologies, LLC, Menlo Park, CA (US)

(72) Inventors: Andrew Maimone, Duvall, WA (US); Mohamed Tarek Ahmed El-Haddad, Redmond, WA (US); Yimin Ding, Kirkland, WA (US); Xinyu Zhu, San Jose, CA (US); Yun-Han Lee, Redmond, WA (US); Sangho Lee, Seoul-si (KR); Don Gyou Lee, Incheon (KR); You-Ren Lan, New Taipei City (TW); Yuhsuan Li, Hsinchu City (TW); Linghui Rao, Redmond, WA (US); Shenglin Ye, Palo Alto, CA (US); John-John Van Den Bergh, Turnhout (BE); Harsha Vijay Shah, Turnhout (BE); Janne Hyyti, Seattle, WA (US); Hee Yoon Lee, Los Altos, CA (US); Alejo Lifschitz Arribio, Redmond, WA (US); Christina Spaegele, Mountain View, CA (US)

(21) Appl. No.: 19/663,797

(22) Filed: Apr. 30, 2026

Related U.S. Application Data
(60) Provisional application No. 63/797,514, filed on Apr. 30, 2025.
(60) Provisional application No. 63/801,624, filed on May 7, 2025.
(60) Provisional application No. 63/915,441, filed on Nov. 11, 2025.
(60) Provisional application No. 63/928,324, filed on Dec. 1, 2025.

(51) Int. Cl. G02B 27/01; G02B 6/34; G02F 1/1335

(52) U.S. Cl. CPC G02B 27/0172; G02B 6/34; G02F 1/133607

(57) ABSTRACT

A device for pupil replication and infield imaging, where the device includes a waveguide media having opposed outer surfaces and a plurality of grating elements physically tilted inside the waveguide media such that none of the grating elements are planarly parallel to the opposed outer surfaces of the waveguide media.

### CROSS REFERENCE TO RELATED APPLICATIONS

This application claims the benefit of and priority to U.S. Provisional Patent Application No. 63/797,514, filed 30 Apr. 2025, U.S. Provisional Patent Application No. 63/801,624, filed 7 May 2025, U.S. Provisional Patent Application No. 63/915,441, filed 11 Nov. 2025, U.S. Provisional Patent Application No. 63/928,324, filed 1 Dec. 2025, the disclosures of which are incorporated herein, in their entirety, by this reference.

### BRIEF DESCRIPTION OF DRAWINGS

FIG. 1 is a flow diagram illustrating example methods for pupil replication according to some embodiments of this disclosure.

FIG. 2 is a block diagram illustrating an example geodiffractive waveguide with transmissive diffractive elements according to some embodiments of this disclosure.

FIG. 3 is a graphical illustration depicting example angular magnification of a tilted grating in air according to some embodiments of this disclosure.

FIG. 4 is a graphical illustration depicting example waveguide fields of view according to some embodiments of this disclosure.

FIG. 5 is a graphical illustration depicting example waveguide fields of view according to some embodiments of this disclosure.

FIG. 6 is a graphical illustration depicting example angular analyses according to some embodiments of this disclosure.

FIG. 7 is a graphical illustration depicting example waveguide incoupling according to some embodiments of this disclosure.

FIG. 8 is a graphical illustration depicting an example waveguide field of view according to some embodiments of this disclosure.

FIG. 9 is a graphical illustration depicting example waveguide color dispersion according to some embodiments of this disclosure.

FIG. 10 is a graphical illustration depicting example waveguide ghosting effects according to some embodiments of this disclosure.

FIG. 11 is a graphical illustration depicting an example layout for two-dimensional expansion according to some embodiments of this disclosure.

FIG. 12 is a graphical illustration depicting example field of view and plate size targets according to some embodiments of this disclosure.

FIG. 13 is a graphical illustration depicting example two-dimensional expansion designs according to some embodiments of this disclosure.

FIG. 14 is a graphical illustration depicting an example two-dimensional expansion design according to some embodiments of this disclosure.

FIG. 15 is a graphical illustration depicting an example two-dimensional expansion design according to some embodiments of this disclosure.

FIG. 16 is a graphical illustration depicting example geometric behavior models according to some embodiments of this disclosure.

FIG. 17 is a graphical illustration depicting example raytraces according to some embodiments of this disclosure.

FIG. 18 is a graphical illustration depicting example three-dimensional layouts for infield imaging according to some embodiments of this disclosure.

FIG. 19 is a graphical illustration depicting example fields of view for infield imaging according to some embodiments of this disclosure.

FIG. 20 is a graphical illustration depicting example gridded points for infield imaging according to some embodiments of this disclosure.

FIG. 21 is a graphical illustration depicting example imaging of the gridded points of FIG. 20.

FIG. 22 is a graphical illustration depicting example gridded points for infield imaging according to some embodiments of this disclosure.

FIG. 23 is a graphical illustration depicting example imaging of the gridded points of FIG. 22.

FIG. 24 is an illustration of an example augmented-reality system according to some embodiments of this disclosure.

FIG. 25A is an illustration of an example virtual-reality system according to some embodiments of this disclosure.

FIG. 25B is an illustration of another perspective of the virtual-reality systems shown in FIG. 25A.

FIG. 26 is an illustration of an example system that incorporates an eye-tracking subsystem capable of tracking a user's eye(s).

FIG. 27 is a more detailed illustration of various aspects of the eye-tracking subsystem illustrated in FIG. 26.

FIG. 28 illustrates a network architecture used to communicate with a system incorporating moiré pattern reduction in an LCD backlight unit, according to some embodiments.

FIG. 29 is a block diagram illustrating details of a system including a display incorporating moiré pattern reduction in an LCD backlight unit, according to some embodiments.

FIG. 30 depicts portions of an LCD backlight unit, in accordance with an illustrative embodiment.

FIG. 31 depicts additional detail of a pyramid-prism film used in an LCD backlight unit, in accordance with an illustrative embodiment.

FIG. 32 depicts an example of moiré pattern reduction in an LCD backlight unit, in accordance with an illustrative embodiment.

FIG. 33 depicts another example of moiré pattern reduction in an LCD backlight unit, in accordance with an illustrative embodiment.

FIG. 34 depicts another example of moiré pattern reduction in an LCD backlight unit, in accordance with an illustrative embodiment.

FIG. 35 depicts another example of moiré pattern reduction in an LCD backlight unit, in accordance with an illustrative embodiment.

FIG. 36 depicts another example of moirépattern reduction in an LCD backlight unit, in accordance with an illustrative embodiment.

FIG. 37 depicts another example of moiré pattern reduction in an LCD backlight unit, in accordance with an illustrative embodiment.

FIG. 38 depicts another example of moiré pattern reduction in an LCD backlight unit, in accordance with an illustrative embodiment.

FIG. 39 depicts another example of moiré pattern reduction in an LCD backlight unit, in accordance with an illustrative embodiment.

FIG. 40 depicts another example of moiré pattern reduction in an LCD backlight unit, in accordance with an illustrative embodiment.

FIG. 41 depicts another example of moiré pattern reduction in an LCD backlight unit, in accordance with an illustrative embodiment.

FIG. 42 depicts another example of moiré pattern reduction in an LCD backlight unit, in accordance with an illustrative embodiment.

FIG. 43 depicts another example of moiré pattern reduction in an LCD backlight unit, in accordance with an illustrative embodiment.

FIG. 44 depicts another example of moiré pattern reduction in an LCD backlight unit, in accordance with an illustrative embodiment.

FIG. 45 depicts another example of moiré pattern reduction in an LCD backlight unit, in accordance with an illustrative embodiment.

FIG. 46 depicts another example of moiré pattern reduction in an LCD backlight unit, in accordance with an illustrative embodiment.

FIG. 47 depicts another example of moiré pattern reduction in an LCD backlight unit, in accordance with an illustrative embodiment.

FIG. 48 depicts another example of moiré pattern reduction in an LCD backlight unit, in accordance with an illustrative embodiment.

FIG. 49 depicts another example of moiré pattern reduction in an LCD backlight unit, in accordance with an illustrative embodiment.

FIG. 50 depicts an example of an optical clear adhesive chart, in accordance with an illustrative embodiment.

FIG. 51 depicts an example of a polarization-selective grating, in accordance with an illustrative embodiment.

FIG. 52 depicts another example of a polarization-selective grating, in accordance with an illustrative embodiment.

FIG. 53 depicts another example of a polarization-selective grating, in accordance with an illustrative embodiment.

FIG. 54 depicts another example of a polarization-selective grating, in accordance with an illustrative embodiment.

FIG. 55 depicts another example of a polarization-selective grating, in accordance with an illustrative embodiment.

FIG. 56 depicts another example of a polarization-selective grating, in accordance with an illustrative embodiment.

FIG. 57 depicts another example of a polarization-selective grating, in accordance with an illustrative embodiment.

FIG. 58 depicts another example of a polarization-selective grating, in accordance with an illustrative embodiment.

FIG. 59 depicts another example of a polarization-selective grating, in accordance with an illustrative embodiment.

FIG. 60 depicts another example of a polarization-selective grating, in accordance with an illustrative embodiment.

FIG. 61 depicts another example of a polarization-selective grating, in accordance with an illustrative embodiment.

FIG. 62 depicts another example of a polarization-selective grating, in accordance with an illustrative embodiment.

### DETAILED DESCRIPTION OF EXEMPLARY EMBODIMENTS

### Systems and Methods for Pupil Replication and Infield Imaging

A pupil replicating waveguide is a type of waveguide used in augmented reality (AR) and head mounted display systems that utilizes light guiding and replication techniques to create a larger, effective image (eyebox) from a smaller display panel, while also maximizing the field of view (FoV). An example pupil-replication process may generate manifold shifted copies of a wavefront having different optical paths inside the waveguide, that interfere with each other so that the phase and intensity of the final output wavefront is intricately scrambled.

Pupil replicating waveguides are the primary approach being explored in the AR industry for AR glasses. These waveguides may have various structures for in/outcoupling and folding the light in the waveguide. Two main approaches used for waveguides may include diffractive waveguides, which have diffractive structures (e.g., surface relief grating (SRG), volume bragg grating (VBG), polarization volume hologram (PVH), metasurface, etc.) parallel to the waveguide surface, and usually on the surface, and geometric waveguides, which have tilted embedded partial mirrors in the waveguide.

Some of the main challenges in pupil replicating waveguides include supporting a large FOV and having a small and light enough waveguide to be used in a form factor like eyeglasses. In particular, the FOV has a hard limit dictated by the index of refraction of the waveguide substrate. However, substrates with very high indices of refraction are needed to support a large FOV, but are currently exotic and extremely expensive. Also, some grating technologies (e.g. VBG are PVH) are only compatible with low to moderate index.

Eye tracking is a technology that measures and records eye movements. It uses infrared cameras or other sensors to detect the position and movement of the pupils and irises, providing information about where a person is looking and how they are focusing their attention. Example types of eye tracking techniques may include infield imaging and amplitude transition function (ATF).

Infield imaging, in the context of eye tracking, may refer to techniques that use light sources and imaging within the user's field of view to track eye movements, often for applications like near eye displays or smartglasses. Infield imaging for eye tracking involves placing light sources and cameras within the user's field of view, allowing for the capture of eye movements and gaze direction without requiring external trackers.

A saccade is a quick, jerky eye movement that shifts your gaze from one point to another. Saccades occur in activities like reading, seeing, and moving around. In the context of saccadic eye movements, ATF describes how the amplitude of the initial saccade changes as a function of the delay between the onset of the second target and the commencement of the saccade.

Infield imaging is superior to ATF for eye tracking (ET) due to issues such as occlusions, interpupillary distance (ID), and population coverage. A best camera view is horizontally centered which is physically infeasible because it will block the user's view in that location. Waveguide imaging places a virtual camera pupil infield while shifting the physical pupil out of the user's FOV. Integration into AR devices is challenging because FOV is tied to index contrast. Inclusion of an eye tracking waveguide either introduces additional air gaps that increase thickness and/or reduce mechanical robustness, does not introduce air gaps but accepts a smaller FOV due to reduced index contrast at one of the interfaces, or adds a hot mirror having an exceptionally challenging coating design.

The present disclosure is generally directed to systems and methods for pupil replication and infield imaging. For example, by embedding diffractive structures that are physically tilted inside a waveguide substrate, rather than parallel to a waveguide surface, a waveguide may be realized that breaks the conventional FOV limit dictated by index of refraction. Breaking this conventional FOV limit may achieve a larger FOV using conventional and lower cost substrates. Hereinafter referred to as a geodiffractive waveguide, this waveguide may be employed as a pupil replicating waveguide for displaying images and/or as an infield imaging waveguide for eye tracking in a head mounted display.

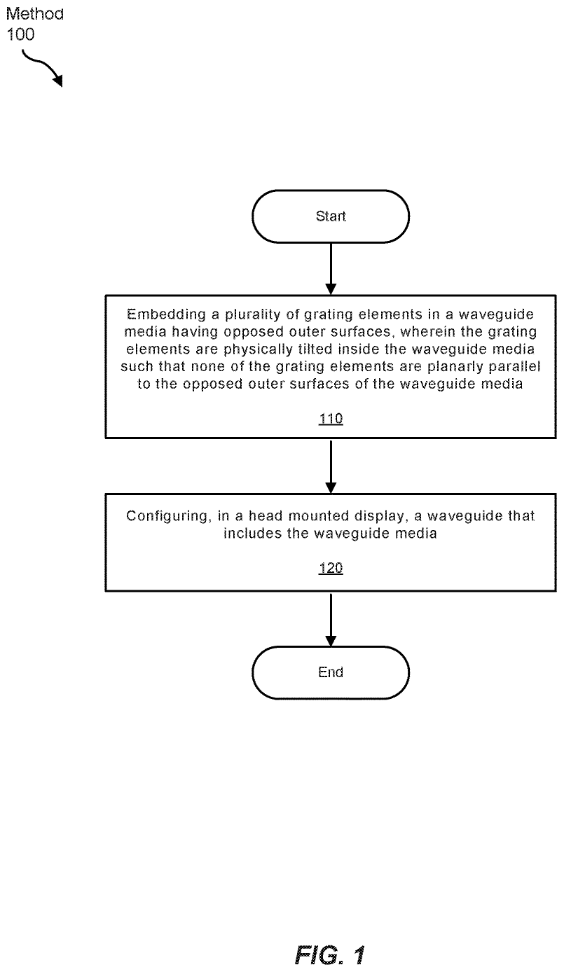

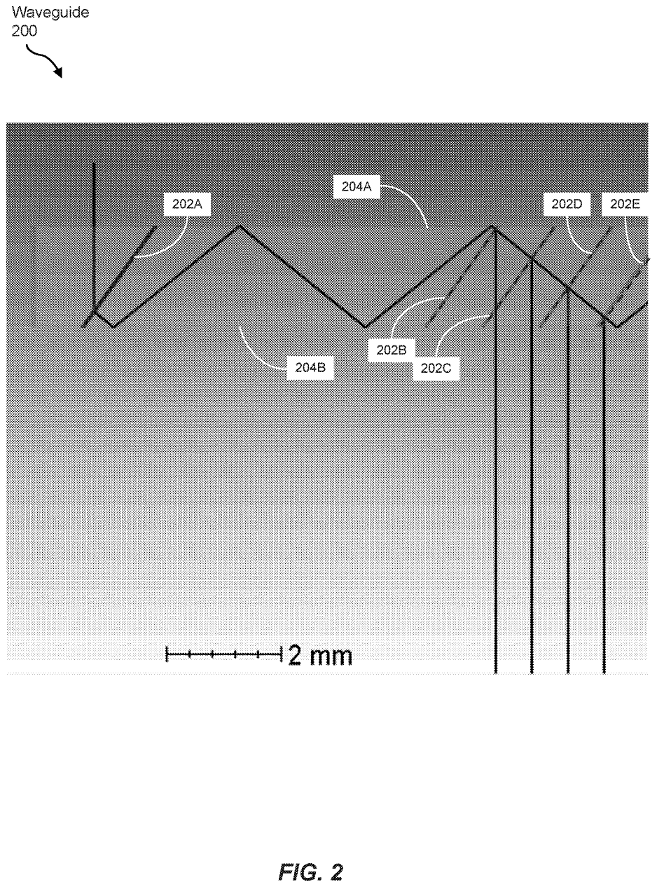

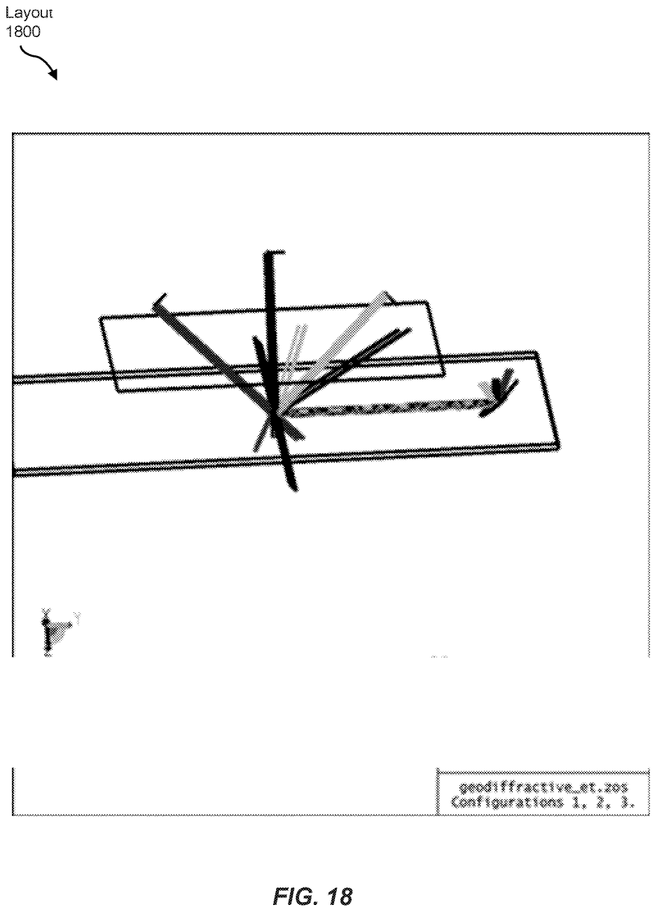

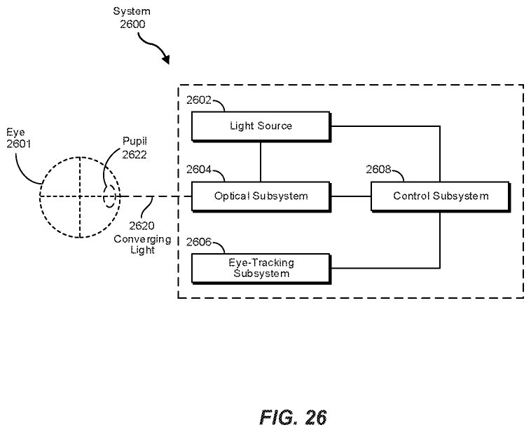

Details of a methods for making and/or configuring waveguides in head mounted displays are provided in connection with FIG. 1. Details of a geodiffractive waveguide implemented to perform pupil replication in display of images to a user of a head mounted display are provided in connection with FIGS. 2-17. Details of a geodiffractive waveguide implemented to perform infield imaging for eye tracking in a head mounted display are provided in connection with FIGS. 18-23. Details of head mounted displays implementing a geodiffractive waveguide for image display and/or eye tracking are provided in connection with FIGS. 26-29.

FIG. 1 illustrates example method 100 for pupil replication. For example, method 100 may be performed by technicians skilled in the art with the aid of equipment, by automated equipment, or combinations thereof. Performance of method 100 may entail performing a series of precision machining and assembly processes. Example processes may include material selection, material preparation, bending and forming, machining, welding, brazing, soldering, RF testing, surface treatment and finish, quality control, packaging and shipping, documentation, customization, or combinations thereof.

As shown in FIG. 1 at step 110, method 100 may include embedding grating elements in a waveguide media. For example, method 100 may, at step 110, include embedding a plurality of grating elements in a waveguide media having opposed outer surfaces, wherein the grating elements are physically tilted inside the waveguide media such that none of the grating elements are planarly parallel to the opposed outer surfaces of the waveguide media.

As shown in FIG. 1, method 100 may perform step 110 in various ways. For example, a stack/slice process may be employed at step 110 in which features such as the gratings are formed on top of planar substrates and stacked, followed by cutting and polishing the stack at an angle according to the angle of the embedded gratings. Additionally, a molding process may be employed at step 110 in which the top and bottom half of the waveguide may be molded and separated at the tilted structures. Then the gratings may be applied to the tilted surfaces of the bottom mold, followed by applying optical adhesive to join the two parts. In this context, the gratings may be applied with various methods at step 110 depending on the grating technology (e.g., nanoimprint or etching (e.g., SRG, metasurface) or applying and exposing photosensitive materials (e.g., VBG, PVH)). Alternatively, some structures like SRG may be directly incorporated into the molds at step 110. In some cases, an overcoat may be applied at step 110 to control the index contrast between the grating structures and the waveguide substrate. Finally, a direct exposure process may be employed at step 110 in which all or a large part of the waveguide includes a photosensitive material (e.g., photopolymer). This photosensitive volume may be exposed with light beams at step 110 that form thin, tilted, diffractive structures directly in the material. In this context, potential approaches used at step 110 include tomographic exposure techniques or using interference of very short laser pulses (e.g., femtosecond scale).

As shown in FIG. 1, method 100 may embed various types of gratings or combinations of gratings in various configurations. For example, the plurality of grating elements embedded at step 110 may include one or more transmissive grating element. In this context, all or a portion of the grating elements embedded at step 110 may be transmissive grating elements. In another example, the plurality of grating elements embedded at step 110 may include one or more reflective grating element. In this context, all or a portion of the grating elements embedded at step 110 may be reflective grating elements. In another example, the plurality of grating elements embedded at step 110 may include a combination of transmissive grating elements and reflective grating elements. Also, the plurality of grating elements embedded in step 110 may include one or more incouplers, one or more outcouplers, and/or one or more fold elements. Further, an index of refraction of the waveguide may lie in a range (e.g., 1.5 to 2.7, 1.5 to 1.8, no greater than 1.52, etc.). Further, a waveguide that includes the waveguide media may achieve a filed of view of at least fifty degrees (e.g., in a range of fifty to sixty degrees, at least sixty degrees, at least seventy degrees, at least eighty degrees, etc.) in at least one dimension (e.g., horizontal, vertical, etc.).

As shown in FIG. 1 at step 120, method 100 may include configuring a waveguide. For example, method 100 may, at step 120, include configuring, in a head mounted display, a waveguide that includes the waveguide media.

As shown in FIG. 1, method 100 may perform step 120 in various ways. For example, the waveguide may be configured at step 120 for pupil replication in the head mounted display. In this context, the waveguide may be configured to receive image light and display a corresponding image to an eye of a user of the head mounted display. In another example, the waveguide may be configured at step 120 for infield imaging in the head mounted display. In this context, the waveguide may be positioned to receive light reflected from an eye of a user of the head mounted display and guide the received light to a pinhole imager of the head mounted display to accomplish eye tracking.

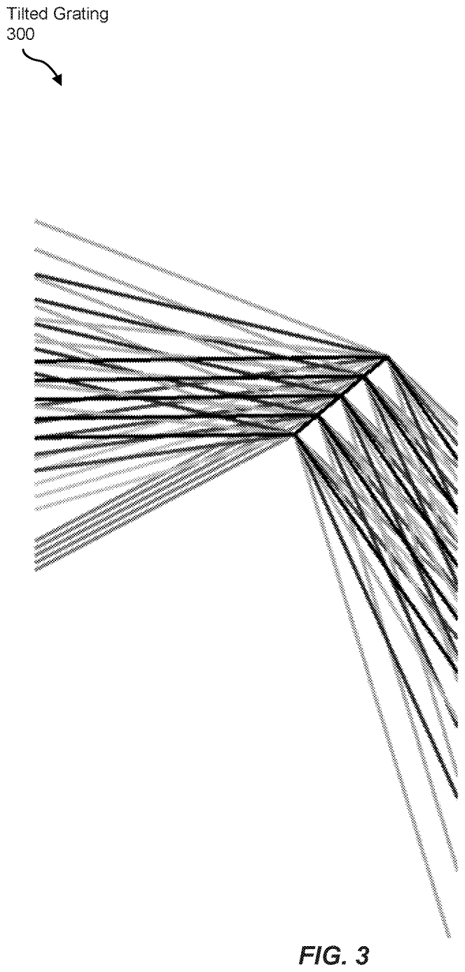

FIG. 2 illustrates an example geodiffractive waveguide 200 with transmissive diffractive elements 202A-202E may be physically tilted inside the waveguide media, like a geometric waveguide, but may include a transmissive or reflective grating, rather than a mirror. The physical tilting of the transmissive diffractive elements 202A-202E may ensure that none of the transmissive diffractive elements 202A-202E are planarly parallel to opposing outer surfaces 204A and 204B of the waveguide. In this context, some of the transmissive diffractive elements 202A-202E may be transmissive gratings while others of the transmissive diffractive elements 202A-202E may be reflective gratings. Alternatively, all of the transmissive diffractive elements 202A-202E may be either transmissive gratings or reflective gratings. This arrangement may achieve compression of the space of angles inside the waveguide, allowing a larger FOV than diffractive or geometric guides using the same index. Angular compression can also be used to reduce the plate size in 2D expansion. FIGS. 3-17 detail some first order analysis for geodiffractive waveguides from a geometric standpoint in the context of achieving a large FOV, single plate RGB waveguide of reasonable size using low index media.

FIG. 3 illustrates example angular magnification of a tilted grating 300 in air. In the context of gratings and angular compression, an off-axis or tilted grating may significantly magnify (or reduce) a set of incident angles, following the grating equation. The geodiffractive waveguide may take advantage of this effect to create a large range of angles outside the waveguide (i.e. a large FOV) and compress them into a smaller set of total internal reflection (TIR) angles available to low index media. Similarly, fan out inside the waveguide and waveguide size may be reduced.

Etendue may refer to a product of an area of a source and a solid angle subtended by its light. By etendue preservation, reducing the range of angles may increase pupil size inside the waveguide. Fields at one edge of the FOV may also have small pupils if the tilted grating is at an oblique angle. To compensate, a thicker guide may be used to support a minimum diffraction limited resolution for peripheral fields and/or denser replication. Some of the examples presented herein may assume that gratings have some efficiency in either the +1 transmission or +1 reflection order and transmit the remaining energy. Otherwise, no special functionality such as angular selectivity or multiplexing is assumed.

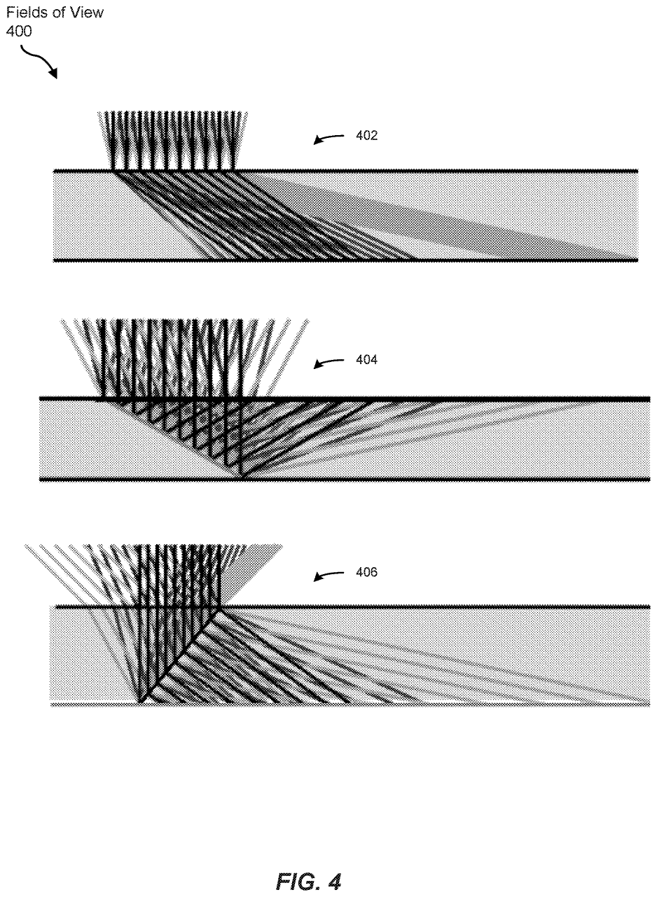

FIG. 4 illustrates example waveguide fields of view 400, including a diffractive waveguide raytrace 402, a geometric waveguide raytrace 404, and a geodiffractive waveguide raytrace 406. Unlike diffractive and geometric waveguides, geodiffractive waveguides do not always have a hard limit on FOV based on TIR angles. In the geodiffractive waveguide raytrace 406, the pupil for the yellow peripheral field (−45°) is small since it is at an oblique angle to the incoupler. Increasing the obliquity allows larger angular compression but yields smaller minimum pupil sizes. The theoretical upper FOV limit of a monochromatic geodiffractive guide approaches 180°×180° in moderate index media with 2D expansion.

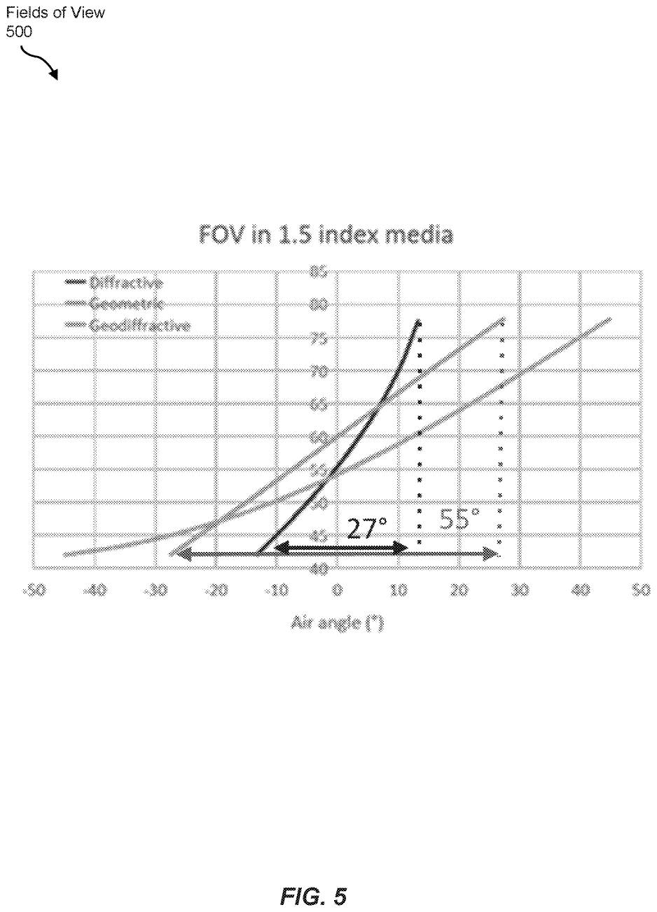

FIG. 5 illustrates example waveguide fields of view 500 for diffractive, geometric, and geodiffractive waveguides. The upper FOV limit of a geodiffractive waveguide may be dictated by the smallest acceptable pupil size. Example FOVs 500 demonstrate that a FOV of 90° may be achieved in a 1.5 index geodiffractive waveguide for one wavelength, whereas diffractive and geometric guides are TIR limited to ~27° and ~55° respectively. Geometric waveguides may have an advantage that they may carry color (RGB) with the same FOV, but aspects relating to RGB are detailed later herein.

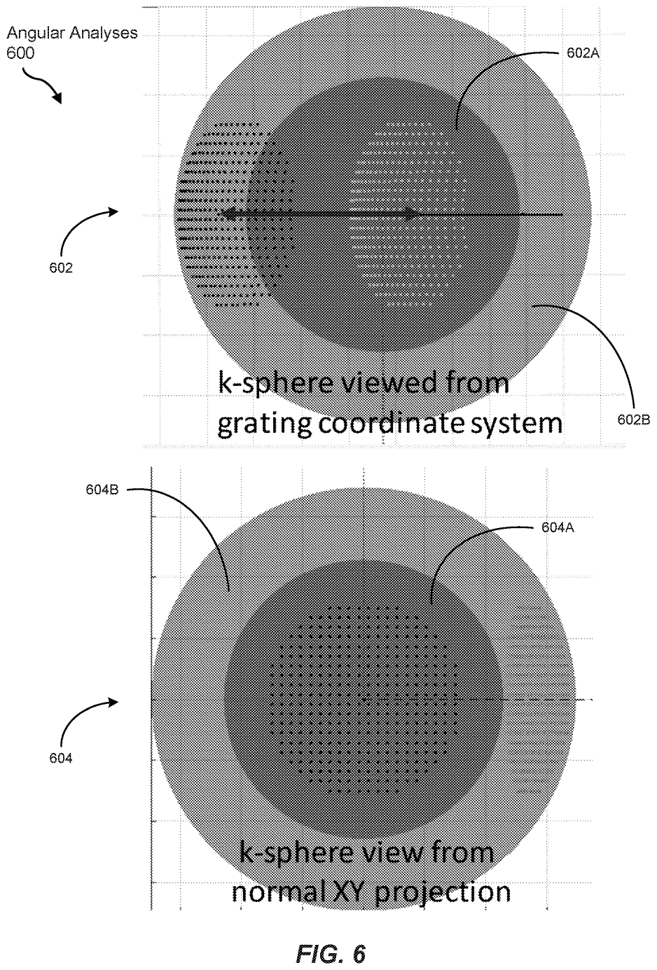

FIG. 6 illustrates example angular analyses 600 using a k-sphere 602 to represent a grating coordinate system and a k-sphere 604 to represent a normal XY projection. In the context of optical gratings (e.g., surface relief grating (SRG), volume bragg grating (VBG), polarization volume hologram (PVH), metasurface, etc.) the “k-sphere” or “Ewald sphere” diagram is a geometric representation that helps visualize the grating vector and Bragg matching conditions during recording and reconstruction. In this context, the k-sphere diagram is a 3D representation where the origin represents the vacuum wave vector, the surface of the sphere represents the wave vectors of the incident (probe) and diffracted beams, and the grating vector, which is the difference between the wave vectors of the interfering beams during recording, is represented as a vector connecting two points on the k-sphere.

As shown in FIG. 6, the effect of a tilted grating in k-space can be found by adding the element's grating vector to the input vector and projecting it on the k-sphere along the normal of the element. This effect cannot be represented as a translation in the XY k-space projection (e.g., a conventional diffractive waveguide) or by a rotation in k-space (e.g., a geometric waveguide). Rather, it is a translation in the local coordinate system of the tilted grating as shown in k-sphere 602, which creates a compressed angle space in the XY k-space projection shown in k-sphere 604. There are four degrees of freedom (DOF) for geodiffractive elements (two tilt DOF, diffractive pitch, and in-plane grating rotation) vs. two for diffractive and geometric guides. These extra DOF can be exploited to maximize FOV, minimize size, and handle RGB. The plots show k-spheres 602A and 604A for air and k-spheres 602B and 604B for ~1.5 index media. The dots show how a 90 deg circular FOV can be compressed to TIR in the low index media, for one wavelength.

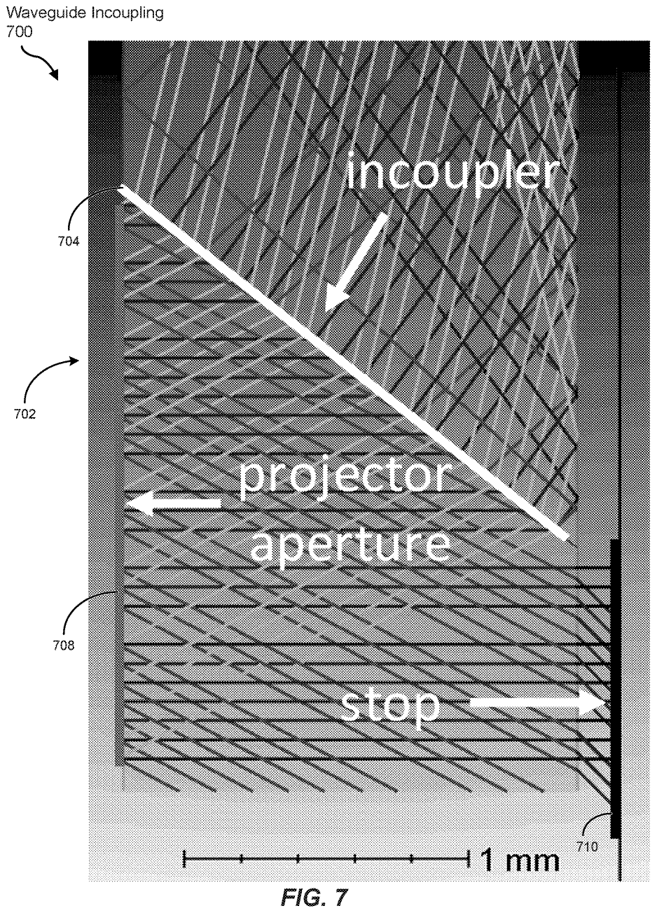

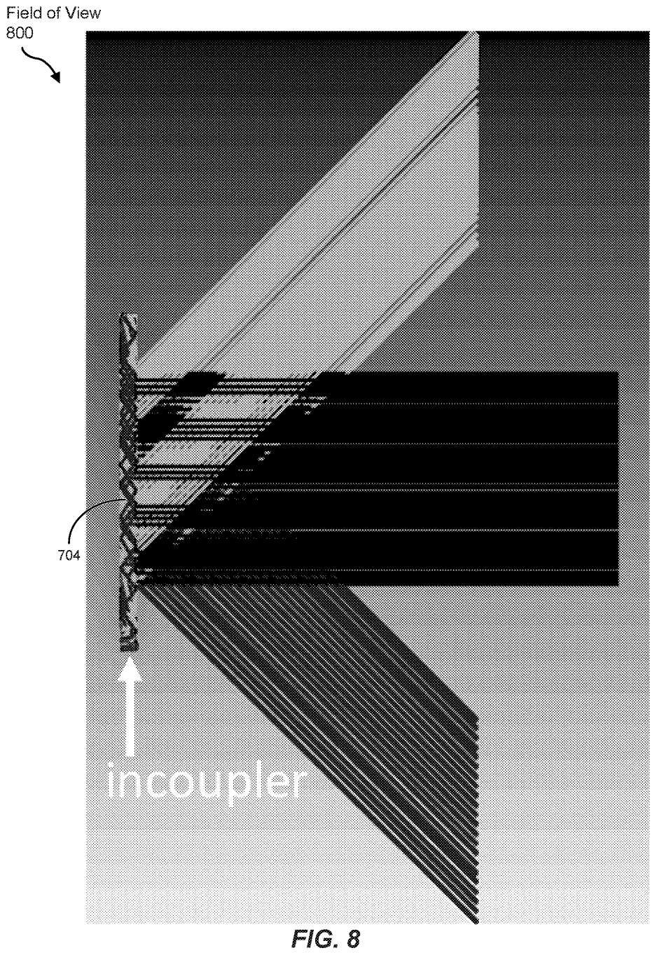

FIGS. 7 and 8 provide examples in the context of one-dimensional (1D) expansion (e.g., using an optical system design simulation tool (e.g., Zemax)). For example, FIG. 7 illustrates example waveguide incoupling 700 and FIG. 8 illustrates an example waveguide field of view 800. These examples demonstrate incoupling in the context of 1D expansion using ~1.5 index media (N-BK7) that is 1.6 mm thick. A geodiffractive element 702 may be used as both an incoupler and an outcoupler array 704. As a pseudo projector, collimated rays form a pupil near the waveguide surface 708 as shown in FIG. 7. In an example, the pupil is the waveguide length in one dimension (e.g., into the screen in FIG. 7) and 2 mm in the other dimension. As shown in FIG. 8, the FOV is 90 deg in air at one wavelength. In this context, the pupil size varies by field due to the tilted element, and some rays miss the incoupler and hit a stop 710. However, in this case, the field with the smallest pupil also has the smallest TIR angle and densest replication, which helps compensate. As shown in the raytrace of FIG. 8, a 90 deg FOV is supported in the TIR direction. This FOV may also be supported in the orthogonal direction.

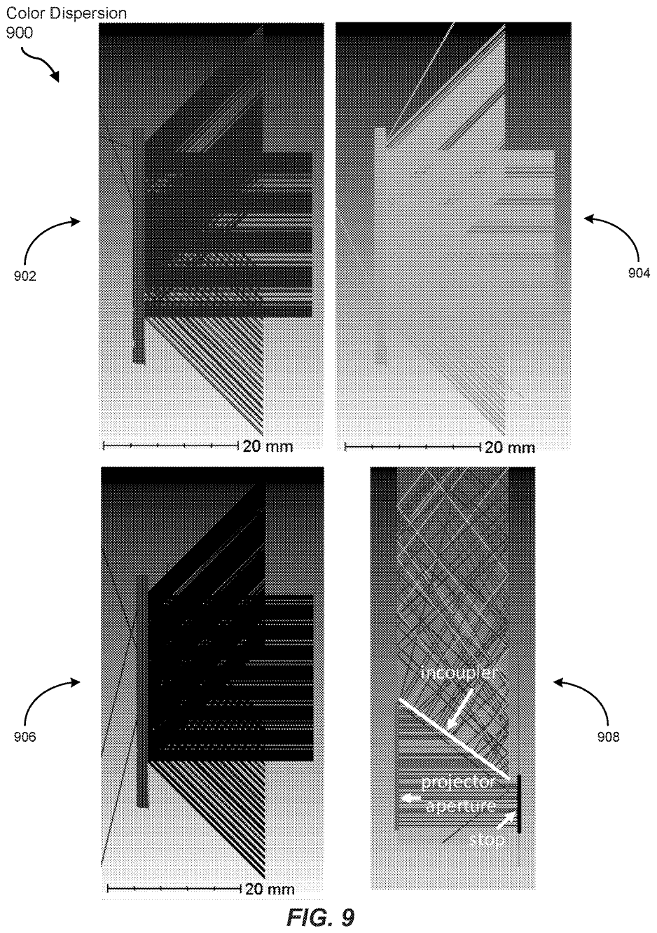

FIG. 9 illustrates example waveguide color dispersion 900. Like diffractive waveguides (and unlike geometric waveguides), geodiffractive waveguides must also deal with dispersion. The amount of dispersion may depend on the configuration. For example, a configuration with a tilted reflective grating and a large diffractive pitch acts more like a geometric element and is less dispersive than a transmissive element where all the ray-bending comes from diffraction.

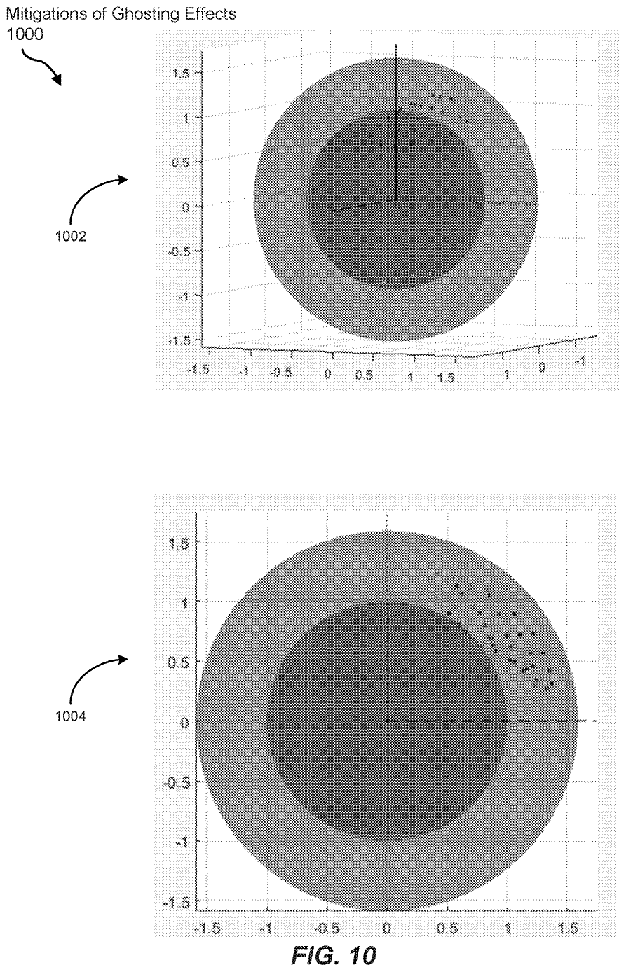

As shown in FIG. 9, examples of 1D expansion 902, 904, and 906 are shown for red (e.g., 650 nm), green (e.g., 550 nm), and blue (e.g., 450 nm) wavelengths of light, respectively. In this context, these examples of 1D expansion 902, 904, and 906 may be examples using a shared in-coupler and out-coupler array 908 with a common pitch. Because of dispersion, some TIR space may be dedicated to handle RGB color like in diffractive guides. In examples of 1D expansion 902, 904, and 906, the index may be increased to 1.78 to support the same 90 deg FOV. Because the in- and out-couplers of the array 908 are symmetric, the design is also dispersion compensated for in-band color. Additional details relating to how the extra DOF of the elements allow more efficient use of the TIR space for RGB color are provided herein with reference to FIGS. 10-17.

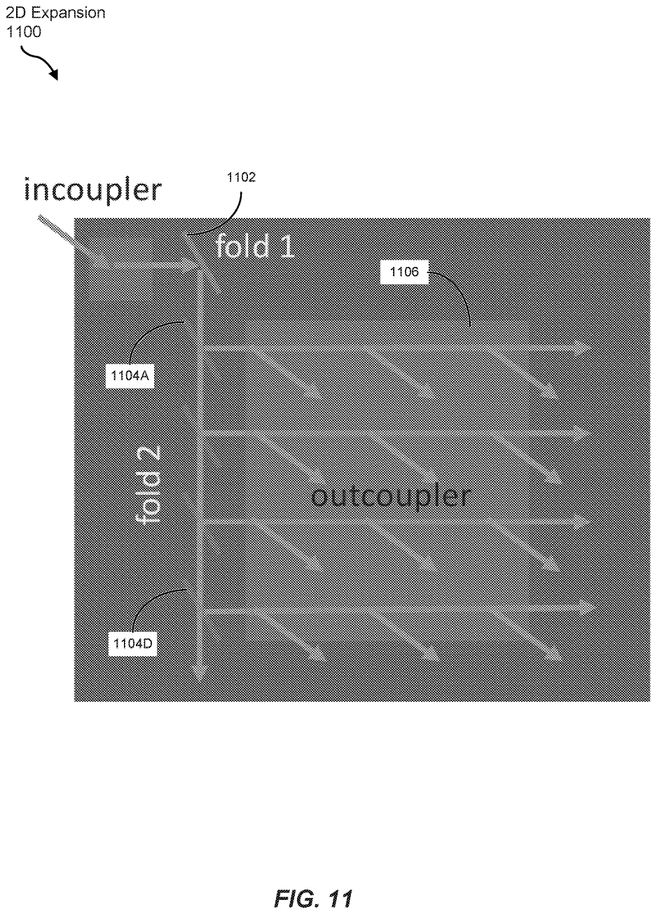

FIG. 10 illustrates example waveguide ghosting effects 1000. Like geometric waveguides, geodiffractive elements generally lack symmetry along the Z axis (i.e. orthogonal to waveguide surface) and thus can have different behavior for rays bouncing forward or backward in the guide. As shown in k-spheres 1002 and 1004, this could result in prominent ghosts that occupy nearly the same set of XY angles as the intended signal but are distorted differently. To mitigate, there are a few options. For example, the waveguide may have a specific geometric configuration where the forward and backward bounce have the same behavior (i.e. Z-symmetric). Alternatively, the element may be engineered so that it only has an effect in one bounce direction (e.g., in the other direction, the diffracted ray cannot exist). Alternatively, an angularly selective grating matched to one bounce direction may be used. Alternatively, the waveguide may be engineered to allow ghosts but cause them to stay outside the eyebox. The Z-symmetric waveguide has the benefit of increasing replication density, but there are only a few possible Z-symmetric elements that are not always applicable. Subsequent examples presented herein involve Z-symmetric waveguides and/or engineering the element so that it only has an effect in one bounce direction. As detailed below with reference to FIG. 11, additional ghosts are possible in two-dimensional (2D) expansion if a ray takes an incorrect path (e.g. ray hits fold before incoupler).

FIG. 11 illustrates an example layout for waveguide two-dimensional expansion 1100. The 1D expansion examples detailed above used a geodiffractive incoupler/outcoupler with symmetric tilt and grating parameters for dispersion compensation. For 2D expansion 1100, a pair of symmetric fold elements may be added to preserve dispersion compensation. The first fold may be a single fold element 1102 that is nominally 100% efficient, and the second fold may be an array of fold elements 1104A-1104D with partial efficiency for splitting. The fold elements 1102 and 1104A-1104D may also be geodiffractive, yielding additional degrees of freedom that may assist in compressing RGB light into the available TIR angles and aid with minimizing (e.g., reduce) plate footprint. 2D expansion 1100 examples presented herein may avoid overlap of fold elements 1102 and 1104A-1104D with outcoupler elements 1106; however, allowing such overlap may open a new design space.

2D expansion 1100 design may be accomplished using design tools (e.g., MATLAB) with custom code to choose the angular space and 2D plate layout. Example user inputs may include target FOV, eyebox size, eye relief, index of media, plate shape, and RGB wavelengths. Using these inputs, a computer implemented procedure may select the tilt and grating parameters for the geodiffractive elements and the projector/eyebox positioning according to various constraints. Example constraints may include that rays must TIR until outcoupling, that element incidence/exitance and TIR angles must be below a specified limit (e.g. 80 degrees), that rays must be distinct and match in forward and backward bounce directions (if they exist), that each ray in FOV/eyebox must have a path from the projector to outcoupler, that elements must stay within a plate boundary, that a fold and outcoupler region must not overlap, and/or that a design is dispersion compensated.

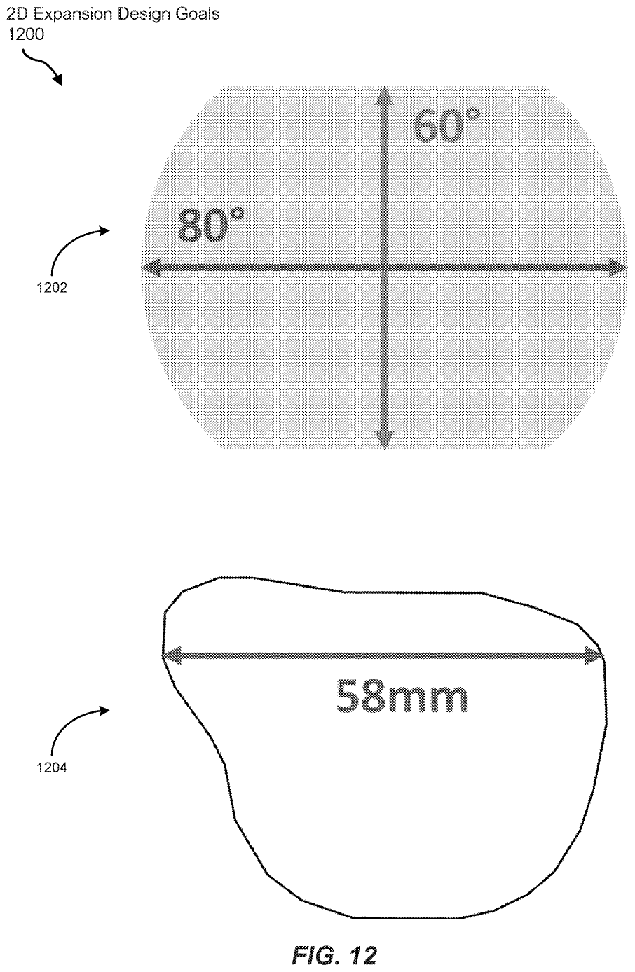

FIG. 12 illustrates example 2D expansion design goals 1200 (e.g., field of view target 1202 and plate size target 1204). For a sample design, goals may be set such as field of view target 1202 (e.g., 80° circular, cropped to 60° vertically), eyebox (e.g., 12 mm circular), eye relief (e.g., 12 mm), media (e.g., 1.59 index (not considering material dispersion)), waveguide shape (e.g., eyeglasses-like profile, plate size target 1204), RGB wavelengths (e.g., 460 nm, 540 nm, 630 nm (w/dispersion compensation)), max element incidence/exitance and TIR angles (e.g., 80°), projector placement (e.g., near top left corner (left eye), RGB projectors may be separated if geometrically advantageous, but not too distant), eyebox placement (e.g., toward top center/right, given typical glasses fit), etc.

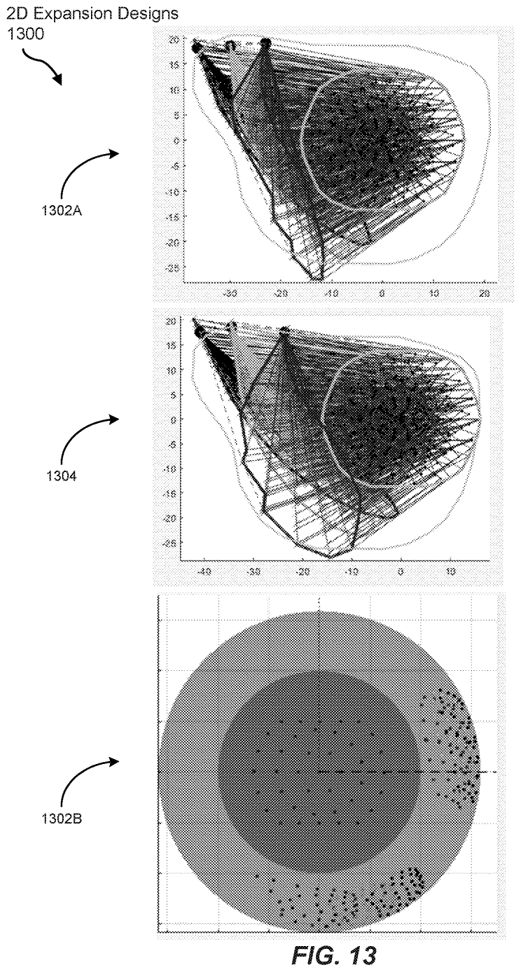

FIGS. 13-15 illustrate example 2D expansion designs 1300, 1400, and 1500. For example, as shown in FIG. 13, two sample 2D expansion designs may be achieved using the computer implemented procedure detailed herein with reference to FIG. 10. Design 1302A and 1302B may avoid ghosts in the fold region by making one bounce direction have no effect. In contrast, design 1304 may avoid ghosts in the fold region by matching the behavior for the forward and reverse bounces. In this context, matching the behavior for the forward and reverse bounces may double fold replication density but make a red fold region larger and the projector and eyebox placement slightly worse. In both design 1302A and 1302B and design 1304, the incoupler and outcouplers may be reflective, and the folds may be transmissive. The 2D layouts shown for design 1302A and 1302B and design 1304 are approximate due to some simplifying assumptions (e.g., the plate is thin and the projector aperture is point-like). These designs mostly meet the aforementioned goals and constraints.

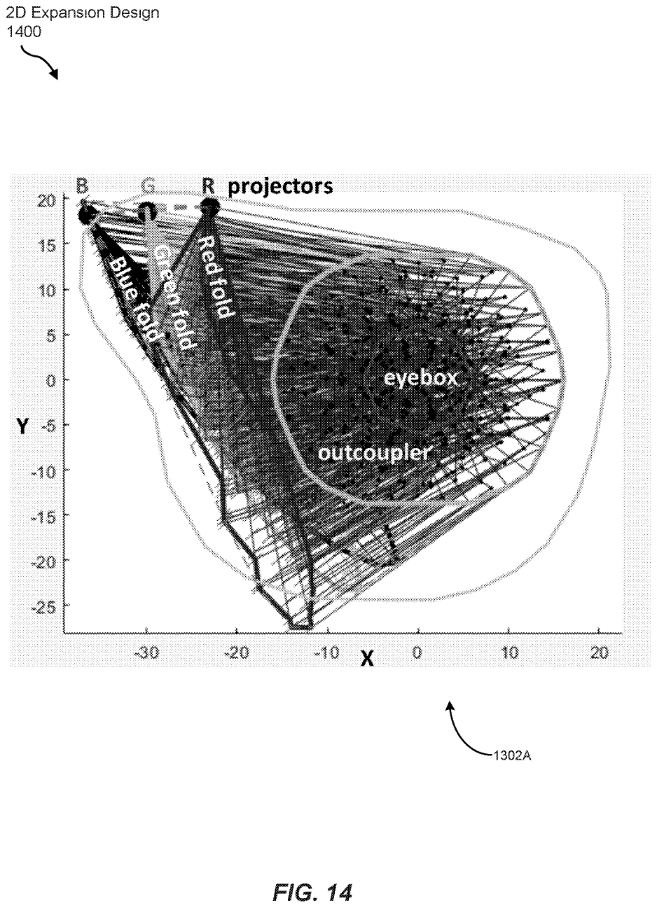

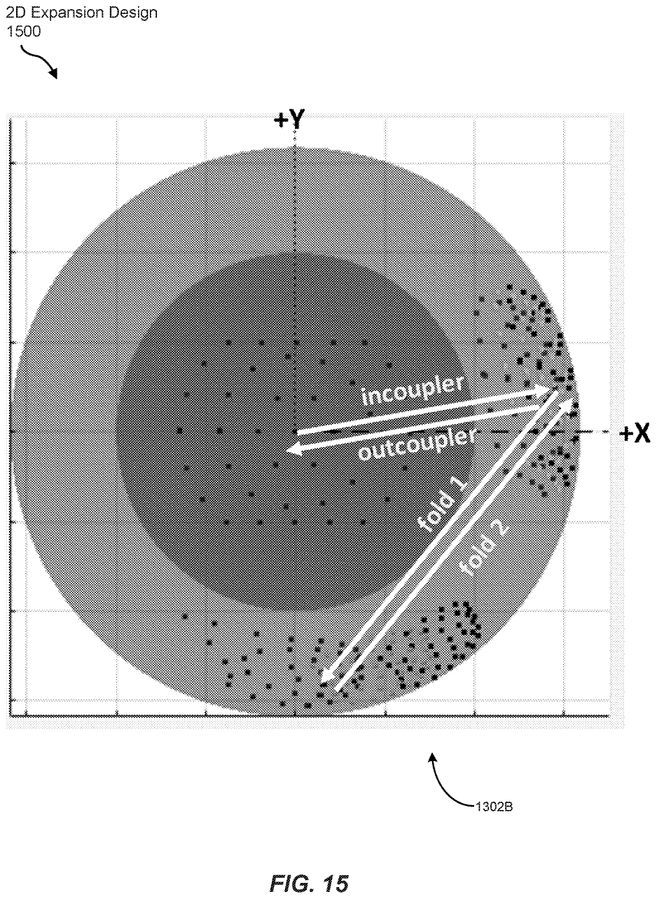

As shown in FIGS. 14 and 15, the computer implemented procedure detailed herein with reference to FIG. 10 does not use the full TIR angle space for design 1302A and 1302B, to avoid ghosts between the forward and reverse bounces. If avoided through other means (e.g. angular selectivity), more favorable designs may be possible. However, the computer implemented procedure detailed herein with reference to FIG. 10 efficiently handles RGB using the extra geodiffractive degrees of freedom. As shown in FIG. 15, the three wavelengths wrap around at the bottom of the k-sphere to fit the sphere.

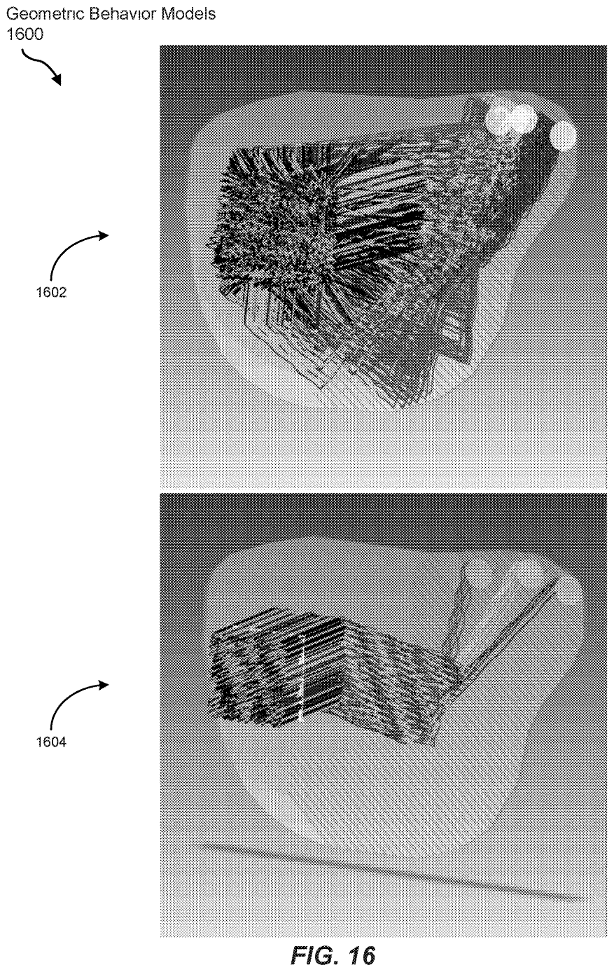

FIG. 16 illustrates example geometric behavior models 1600 using an optical system design simulation tool (e.g., Zemax). For example, geometric behavior model 1602 demonstrates a RGB FOV filtered to rays hitting the eyebox for design 1302A and 1302B of FIGS. 13-15. Also, geometric behavior model 1604 demonstrates a RGB on-axis field filtered to rays hitting the eyebox for design 1304 of FIG. 13. These designs are modelled in FIG. 16 in non-sequential mode for verification of geometric behavior.

As shown in FIG. 16, elements are modelled as in-plane rotated, tilted gratings. Also, couplers use only the +1 reflection order and folds use only the +1 transmission order. Further, incoupler and fold 1 elements are modelled as 100% efficient, non-diffracted energy is transmitted, and arrayed elements are spaced 1 mm apart along the surface normal. Further, the “projector” is represented as ideal collimated ray bundles with a 2 mm aperture at the waveguide surface, which overfills the incoupler by a varying amount, depending on field angle. Further, the plate is non-dispersive 1.0 mm (shown) or 1.6 mm thick index 1.59 media. Because of the simplifying layout assumptions (i.e. the plate is very thin and the projector aperture is point-like), some modifications were made such as the projector positions were adjusted, multiple fold 1 elements were used, and the fold/outcoupler regions were enlarged.

As shown in FIG. 16, the geometric behavior models 1600 show that the sample designs mostly work as intended. For example, the sample designs can handle the expected FOV at the design RGB wavelengths and is dispersion compensated.

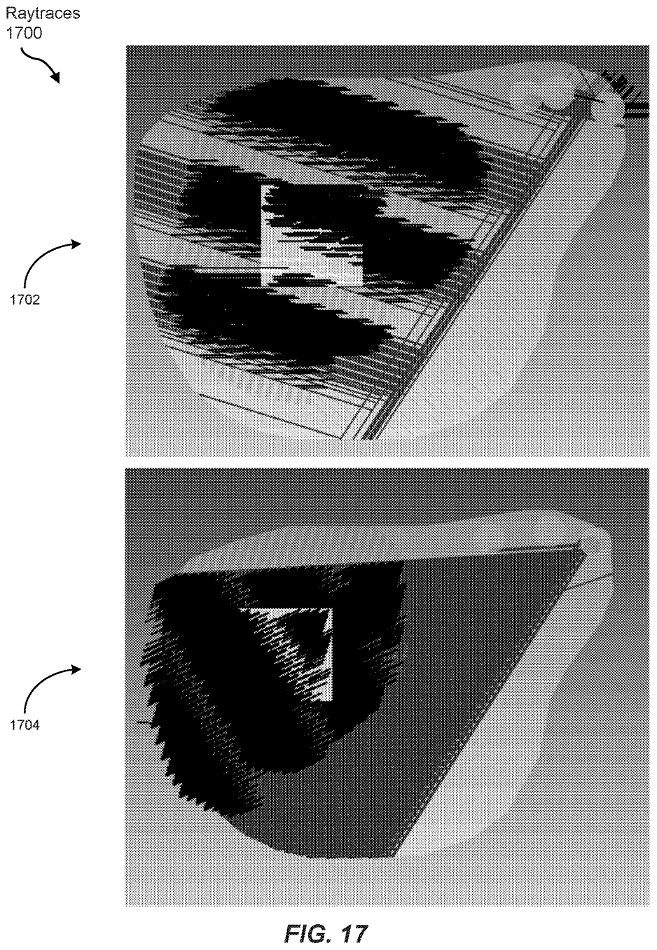

FIG. 17 illustrates example raytraces 1700 that demonstrate differences between design 1302A and 1302B of FIGS. 13-15 (e.g., raytrace 1702) and design 1304 of FIG. 13 (e.g., raytrace 1704). For example, these raytraces 1702 and 1704 show the primary difference between the sample designs for a field with a large TIR angle. As shown by raytrace 1704, design 1304 of FIG. 13 works on both bounce directions in the fold region, so it has higher replication density along this axis. Both designs only operate in a single bounce direction in the outcoupling region.

As set forth above with reference to sample designs, the disclosed geodiffractive waveguide may yield numerous benefits when used for pupil replication. For example, the disclosed geodiffractive waveguide may provide a path to a single plate RGB solution with large FOV in a reasonable plate size. Additionally, the disclosed geodiffractive waveguide may provide a path to reducing cost with low index media (e.g., as low as 1.5×). Also, the disclosed geodiffractive waveguide may provide multiple potential options for grating technology. In this context, the sample designs disclosed herein may assume a “generic” grating without any selectivity or multiplexing, but these designs may assume which diffraction orders exist. Further, limited range of angles inside the disclosed geodiffractive waveguide may provide for better optimization of grating uniformity and efficiency. Still further, the disclosed geodiffractive waveguide may provide multiple potential options for the projector, since the design is dispersion compensated but does not rely on dispersion to fill out the FOV. Finally, the ability to make overlapping elements will open new design spaces.

The disclosed geodiffractive waveguide may be manufactured in various ways. For example, a process may be used to embed a tilted gratings structure within the volume of the waveguide. Additionally, the embedded gratings may correspond to one or more surface relief grating (SRG), volume bragg grating (VBG), polarization volume hologram (PVH), metasurface, etc. Also, the waveguide substrate may be glass and/or plastic, given the low refractive index requirements.

As mentioned above with reference to FIG. 1, one or more of several processes may be used to embed the gratings. For example, a stack/slice process may be employed in which features such as the gratings are formed on top of planar substrates and stacked, followed by cutting and polishing the stack at an angle according to the angle of the embedded gratings. Additionally, a molding process may be employed in which the top and bottom half of the waveguide may be molded and separated at the tilted structures. Then the gratings may be applied to the tilted surfaces of the bottom mold, followed by applying optical adhesive to join the two parts. In this context, the gratings may be applied with various methods depending on the grating technology (e.g., nanoimprint or etching (e.g., SRG, metasurface) or applying and exposing photosensitive materials (e.g., VBG, PVH)). Alternatively, some structures like SRG may be directly incorporated into the molds. In some cases, an overcoat may be applied to control the index contrast between the grating structures and the waveguide substrate. Finally, a direct exposure process may be employed in which all or a large part of the waveguide includes a photosensitive material (e.g., photopolymer). This photosensitive volume may be exposed with light beams that form thin, tilted, diffractive structures directly in the material. In this context, potential approaches include tomographic exposure techniques or using interference of very short laser pulses (e.g., femtosecond scale).

As an alternative or in addition to using the waveguide for pupil replication (e.g., for display), the disclosed geodiffractive waveguide may be used for infield imaging (e.g., for eye tracking) as detailed herein with reference to FIGS. 18-23. As mentioned above, infield imaging is superior to ATF for eye tracking (ET) due to issues such as occlusions, interpupillary distance (ID), and population coverage. A best camera view is horizontally centered which is physically infeasible because it will block the user's view in that location. Waveguide imaging places a virtual camera pupil infield while shifting the physical pupil out of the user's FOV. Integration into AR devices is challenging because FOV is tied to index contrast. Inclusion of an eye tracking waveguide either introduces additional air gaps that increase thickness and/or reduce mechanical robustness, does not introduce air gaps but accepts a smaller FOV due to reduced index contrast at one of the interfaces, or adds a hot mirror having an exceptionally challenging coating design.

As previously detailed with reference to FIGS. 4 and 5, geodiffractive waveguides, unlike diffractive and geometric waveguides, do not always have a hard limit on FOV based on TIR angles. Additionally, the upper FOV limit of a geodiffractive waveguide may be dictated by the smallest acceptable pupil size. Also, a FOV of 90° may be achieved in a 1.5 index geodiffractive waveguide for one wavelength, whereas diffractive and geometric guides are TIR limited to ~27° and ~55° respectively. Further, geometric waveguides may have an advantage that they may carry color (RGB) with the same FOV.

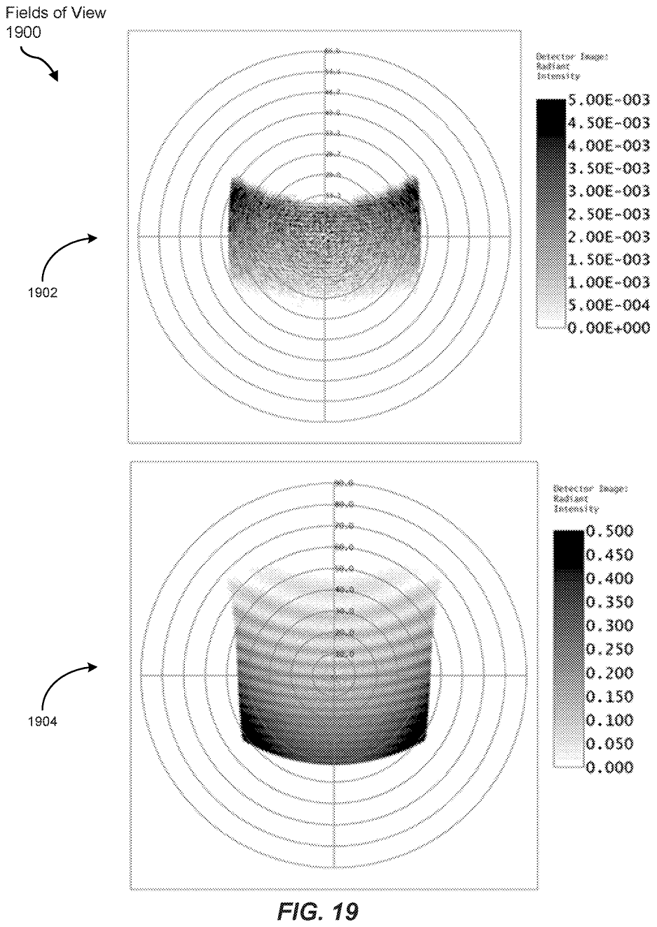

FIG. 18 illustrates example three-dimensional layouts 1800 for infield imaging. In an example, a layout 1800 may implement a geodiffractive waveguide pinhole camera as shown. By placing the grating on a tilted facet inside the waveguide, the FOV may be significantly increased for the same index contrast. Thus, and as detailed below with reference to FIGS. 19-23, the geodiffractive waveguide pinhole camera shown in layout 1800 may achieve an improved FOV (e.g., compared to a diffractive waveguide) to image an eye of a user of a head mounted display. The improved FOV provided by the geodiffractive waveguide pinhole camera may, for example, achieve imaging of twice as many gridded points compared to use of a diffractive waveguide.

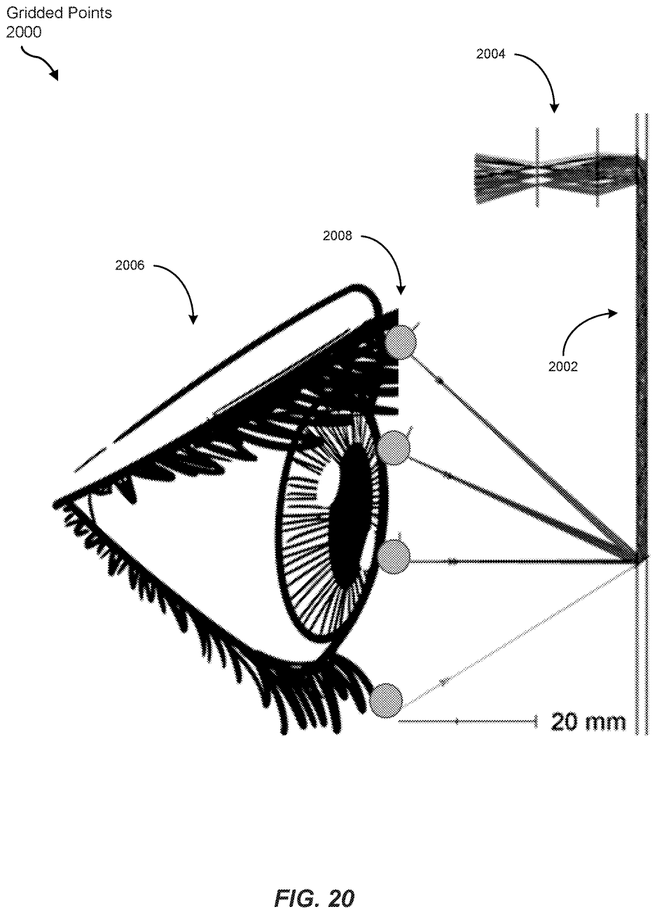

FIG. 19 illustrates a comparison between example fields of view 1900 for infield imaging from a normal diffractive-only waveguide and the geodiffractive waveguide disclosed herein. For example, graph 1902 demonstrates a radiant intensity distribution achieved using a normal diffractive grating-based waveguide pinhole camera. Additionally, graph 1904 demonstrates an increased coverage of radiant intensity achieved using a geodiffractive waveguide pinhole camera having the same waveguide substrate material. As detailed below with reference to FIGS. 20-23, the improved FOV achieved using the geodiffractive waveguide pinhole camera accomplishes imaging of twice as many gridded points compared to use of a diffractive waveguide.

FIG. 20 illustrates example gridded points 2000 for infield imaging. For example, the geodiffractive waveguide 2002 may be combined with an imaging camera module 2004 (e.g., a pinhole imager) and positioned to receive rays of light reflected from an eye 2006 of a user of a head mounted display. A vertical dimension of a FOV of the waveguide 2002 may be sufficient to achieve imaging of a set 2008 of four gridded points that are arranged vertically. A light beam from all four points can be transported through a waveguide 2002 to an imaging camera module 2004 and form four imaging points, respectively. The arrangement of these gridded points may encompass a pupil, iris, and sclera as well as upper and lower lids/lashes of the eye 2006.

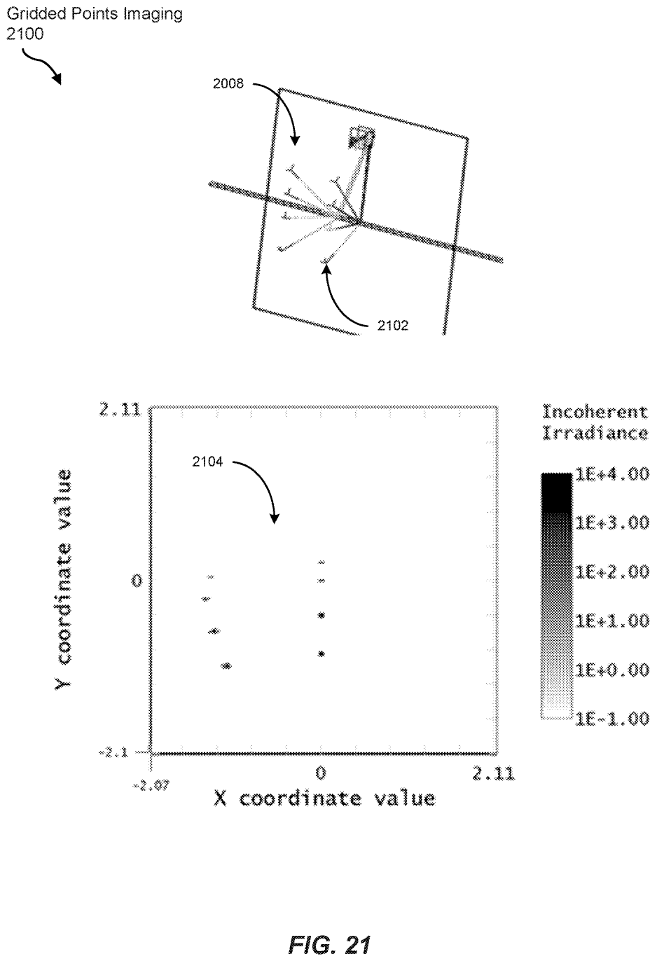

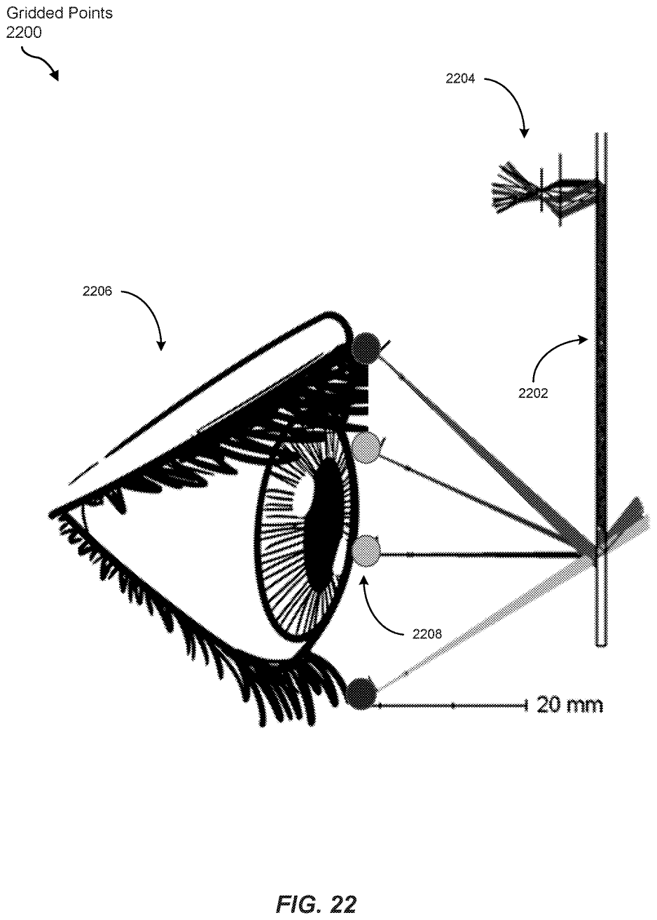

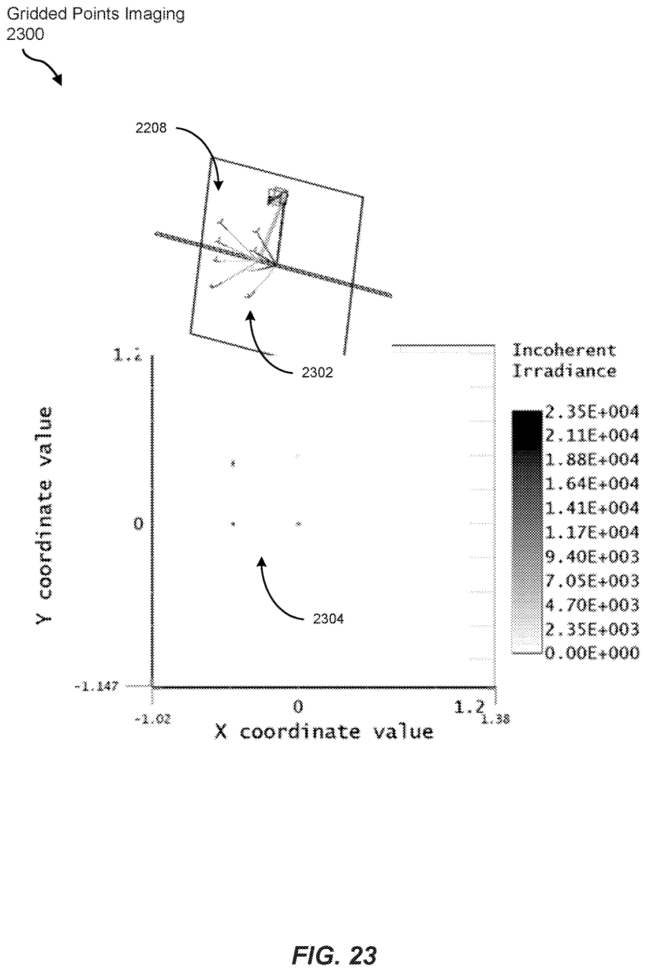

FIG. 21 illustrates example imaging 2100 of the gridded points of FIG. 20. For example, an additional set 2102 of four vertically arranged gridded points horizontally offset from the set 2008 of four vertically arranged gridded points may be imaged, for a total set 2104 of eight imaged gridded points. As detailed below with reference to FIGS. 22 and 23, this total number of gridded points imaged with the geodiffractive waveguide is greater than a total number of gridded points imaged with a diffractive waveguide. This increase (e.g., by one hundred percent) of the total number of imaged gridded points may be due to a larger FOV provided by the geodiffractive waveguide compared to a smaller FOV provided by a diffractive waveguide.

FIG. 22 illustrates example gridded points 2200 for infield imaging. For example, a diffractive waveguide 2202 may be combined with an imaging camera module 2204 (e.g., pinhole imager) and positioned to receive rays of light reflected from an eye 2206 of a user of a head mounted display. A vertical dimension of a FOV of the waveguide 2202 may be sufficient to achieve imaging of a set 2208 of two gridded points that are arranged vertically. A light beam from only two center points can be transported through a waveguide 2202 to an imaging camera module 2204 and form two imaging points, respectively, while a light beam from two other points leak out of the waveguide 2202 to the right and cannot reach the imaging camera module 2204. The arrangement of these gridded points may encompass a pupil and iris of the eye 2206, but not a sclera nor upper and lower lids/lashes.

FIG. 23 illustrates example imaging 2300 of the gridded points of FIG. 22. For example, an additional set 2302 of two vertically arranged gridded points horizontally offset from the set 2208 of two vertically arranged gridded points may be imaged, for a total set 2304 of four imaged gridded points. As detailed above with reference to FIGS. 20 and 21, this total number of gridded points imaged with the diffractive waveguide is less than a total number of gridded points imaged with a geodiffractive waveguide. This decrease (e.g., by one hundred percent) of the total number of imaged gridded points may be due to a smaller FOV provided by the diffractive waveguide compared to a larger FOV provided by a geodiffractive waveguide.

As set forth above, systems and methods for pupil replication and infield imaging may benefit from a larger FOV than is available using diffractive waveguides or geometric waveguides. For example, by embedding diffractive structures that are physically tilted inside a waveguide substrate, rather than parallel to a waveguide surface, a waveguide may be realized that breaks the conventional FOV limit dictated by index of refraction. Breaking this conventional FOV limit may achieve a larger FOV using conventional and lower cost substrates. This waveguide may be employed as a pupil replicating waveguide for displaying images and/or as an infield imaging waveguide for eye tracking in a head mounted display.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality—systems may be designed to work without near-eye displays (NEDs). Other artificial—reality systems may include an NED that also provides visibility into the real world or that visually immerses a user in an artificial reality. While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

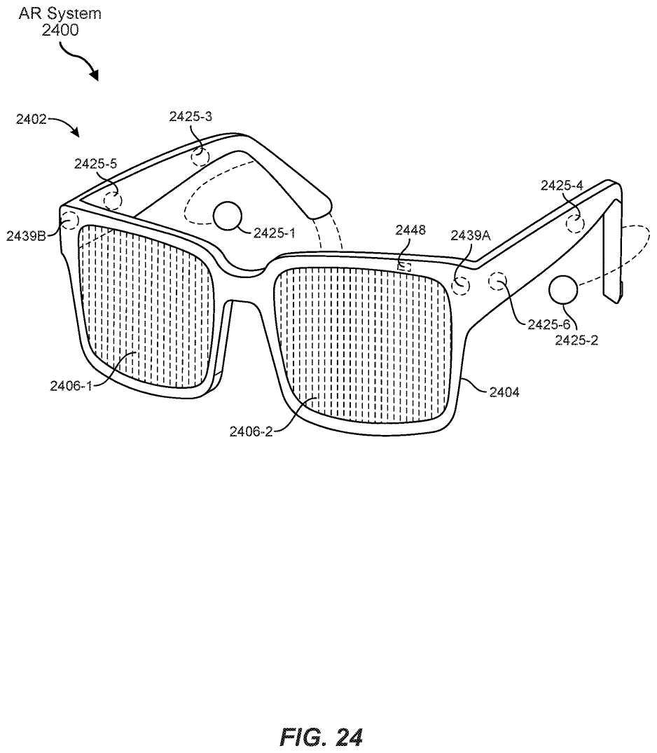

FIG. 24 show an example visual depiction of AR system 2400, including an eyewear device 2402 (which may also be described herein as augmented-reality glasses, and/or smart glasses). AR system 2400 can include additional electronic components that are not shown in FIG. 24, such as a wearable accessory device and/or an intermediary processing device, in electronic communication or otherwise configured to be used in conjunction with the eyewear device 2402. In some embodiments, the wearable accessory device and/or the intermediary processing device may be configured to couple with eyewear device 2402 via a coupling mechanism in electronic communication with a coupling sensor, where the coupling sensor can detect when an electronic device becomes physically or electronically coupled with eyewear device 2402. In some embodiments, eyewear device 2402 can be configured to couple to a housing, which may include one or more additional coupling mechanisms configured to couple with additional accessory devices. The components shown in FIG. 24 can be implemented in hardware, software, firmware, or a combination thereof, including one or more signal-processing components and/or application-specific integrated circuits (ASICs).

Eyewear device 2402 includes mechanical glasses components, including a frame 2404 configured to hold one or more lenses (e.g., one or both lenses 2406-1 and 2406-2). One of ordinary skill in the art will appreciate that eyewear device 2402 can include additional mechanical components, such as hinges configured to allow portions of frame 2404 of eyewear device 2402 to be folded and unfolded, a bridge configured to span the gap between lenses 2406-1 and 2406-2 and rest on the user's nose, nose pads configured to rest on the bridge of the nose and provide support for eyewear device 2402, earpieces configured to rest on the user's ears and provide additional support for eyewear device 2402, temple arms configured to extend from the hinges to the earpieces of eyewear device 2402, and the like. One of ordinary skill in the art will further appreciate that some examples of AR system 2400 can include none of the mechanical components described herein. For example, smart contact lenses configured to present artificial reality to users may not include any components of eyewear device 2402.

Eyewear device 2402 includes electronic components, many of which will be described in more detail below with respect to FIG. 24. Some example electronic components are illustrated in FIG. 24, including acoustic sensors 2425-1, 2425-2, 2425-3, 2425-4, 2425-5, and 2425-6, which can be distributed along a substantial portion of the frame 2404 of eyewear device 2402. Eyewear device 2402 also includes a left camera 2439A and a right camera 2439B, which are located on different sides of the frame 2404. Eyewear device 2402 also includes a processor 2448 (or any other suitable type or form of integrated circuit) that is embedded into a portion of the frame 2404.

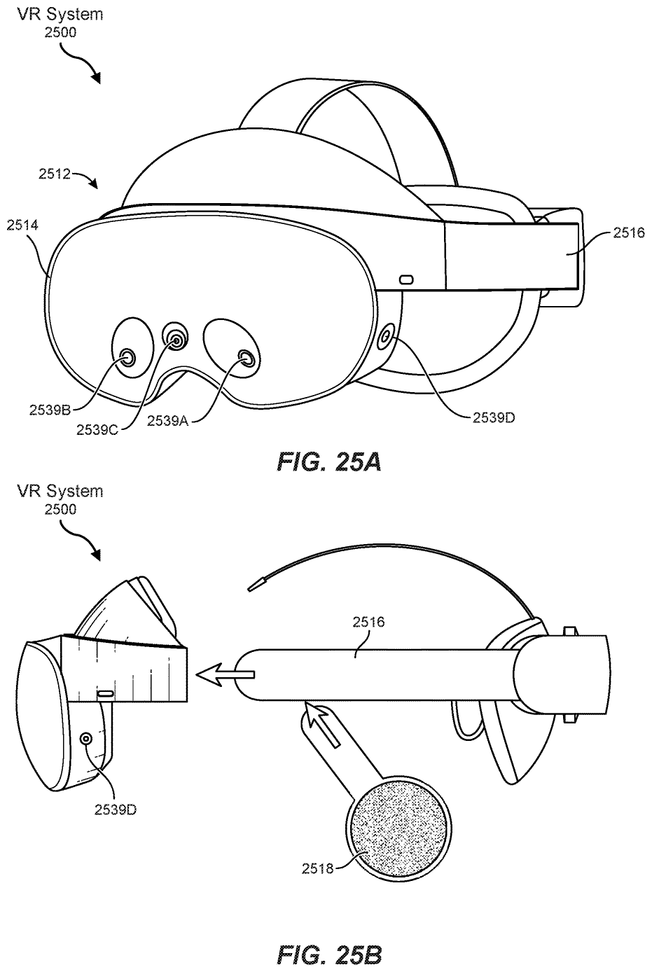

FIGS. 25A and 25B show a VR system 2500 that includes a head-mounted display (HMD) 2512 (e.g., also referred to herein as an artificial-reality headset, a head-wearable device, a VR headset, etc.), in accordance with some embodiments. As noted, some artificial-reality systems (e.g., AR system 2400) may, instead of blending an artificial reality with actual reality, substantially replace one or more of a user's visual and/or other sensory perceptions of the real world with a virtual experience.

HMD 2512 includes a front body 2514 and a frame 2516 (e.g., a strap or band) shaped to fit around a user's head. In some embodiments, front body 2514 and/or frame 2516 include one or more electronic elements for facilitating presentation of and/or interactions with an AR and/or VR system (e.g., displays, IMUs, tracking emitter or detectors). In some embodiments, HMD 2512 includes output audio transducers (e.g., an audio transducer 2518), as shown in FIG. 25B. In some embodiments, one or more components, such as the output audio transducer(s) 2518 and frame 2516, can be configured to attach and detach (e.g., are detachably attachable) to HMD 2512 (e.g., a portion or all of frame 2516, and/or audio transducer 2518), as shown in FIG. 25B. In some embodiments, coupling a detachable component to HMD 2512 causes the detachable component to come into electronic communication with HMD 2512.

FIGS. 25A and 25B also show that VR system 2510 includes one or more cameras, such as left camera 2539A and right camera 2539B, which can be analogous to left and right cameras 2439A and 2439B on frame 2404 of eyewear device 2402. In some embodiments, VR system 2510 includes one or more additional cameras (e.g., cameras 2539C and 2539D), which can be configured to augment image data obtained by left and right cameras 2539A and 2539B by providing more information. For example, camera 2539C can be used to supply color information that is not discerned by cameras 2539A and 2539B. In some embodiments, one or more of cameras 2539A to 2539D can include an optional IR cut filter configured to remove IR light from being received at the respective camera sensors.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

FIG. 26 is an illustration of an example system 2600 that incorporates an eye-tracking subsystem capable of tracking a user's eye(s). As depicted in FIG. 26, system 2600 may include a light source 2602, an optical subsystem 2604, an eye-tracking subsystem 2606, and/or a control subsystem 2608. In some examples, light source 2602 may generate light for an image (e.g., to be presented to an eye 2601 of the viewer). Light source 2602 may represent any of a variety of suitable devices. For example, light source 2602 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 2604 may receive the light generated by light source 2602 and generate, based on the received light, converging light 2620 that includes the image. In some examples, optical subsystem 2604 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 2620. Further, various mechanical couplings may serve to maintain the relative spacing and/or the orientation of the optical components in any suitable combination.

In one embodiment, eye-tracking subsystem 2606 may generate tracking information indicating a gaze angle of an eye 2601 of the viewer. In this embodiment, control subsystem 2608 may control aspects of optical subsystem 2604 (e.g., the angle of incidence of converging light 2620) based at least in part on this tracking information. Additionally, in some examples, control subsystem 2608 may store and utilize historical tracking information (e.g., a history of the tracking information over a given duration, such as the previous second or fraction thereof) to anticipate the gaze angle of eye 2601 (e.g., an angle between the visual axis and the anatomical axis of eye 2601). In some embodiments, eye-tracking subsystem 2606 may detect radiation emanating from some portion of eye 2601 (e.g., the cornea, the iris, the pupil, or the like) to determine the current gaze angle of eye 2601. In other examples, eye-tracking subsystem 2606 may employ a wavefront sensor to track the current location of the pupil.

Any number of techniques can be used to track eye 2601. Some techniques may involve illuminating eye 2601 with infrared light and measuring reflections with at least one optical sensor that is tuned to be sensitive to the infrared light. Information about how the infrared light is reflected from eye 2601 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 2606 may be digitized (i.e., converted to an electronic signal). Further, the sensor may transmit a digital representation of this electronic signal to one or more processors (for example, processors associated with a device including eye-tracking subsystem 2606). Eye-tracking subsystem 2606 may include any of a variety of sensors in a variety of different configurations. For example, eye-tracking subsystem 2606 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 2606 to track the movement of eye 2601. In another example, these processors may track the movements of eye 2601 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 2606 may be programmed to use an output of the sensor(s) to track movement of eye 2601. In some embodiments, eye-tracking subsystem 2606 may analyze the digital representation generated by the sensors to extract eye rotation information from changes in reflections. In one embodiment, eye-tracking subsystem 2606 may use corneal reflections or glints (also known as Purkinje images) and/or the center of the eye's pupil 2622 as features to track over time.

In some embodiments, eye-tracking subsystem 2606 may use the center of the eye's pupil 2622 and infrared or near-infrared, non-collimated light to create corneal reflections. In these embodiments, eye-tracking subsystem 2606 may use the vector between the center of the eye's pupil 2622 and the corneal reflections to compute the gaze direction of eye 2601. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 2606 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 2601 may act as a retroreflector as the light reflects off the retina, thereby creating a bright pupil effect similar to a red-eye effect in photography. If the illumination source is offset from the optical path, then the eye's pupil 2622 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 2608 may control light source 2602 and/or optical subsystem 2604 to reduce optical aberrations (e.g., chromatic aberrations and/or monochromatic aberrations) of the image that may be caused by or influenced by eye 2601. In some examples, as mentioned above, control subsystem 2608 may use the tracking information from eye-tracking subsystem 2606 to perform such control. For example, in controlling light source 2602, control subsystem 2608 may alter the light generated by light source 2602 (e.g., by way of image rendering) to modify (e.g., pre-distort) the image so that the aberration of the image caused by eye 2601 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

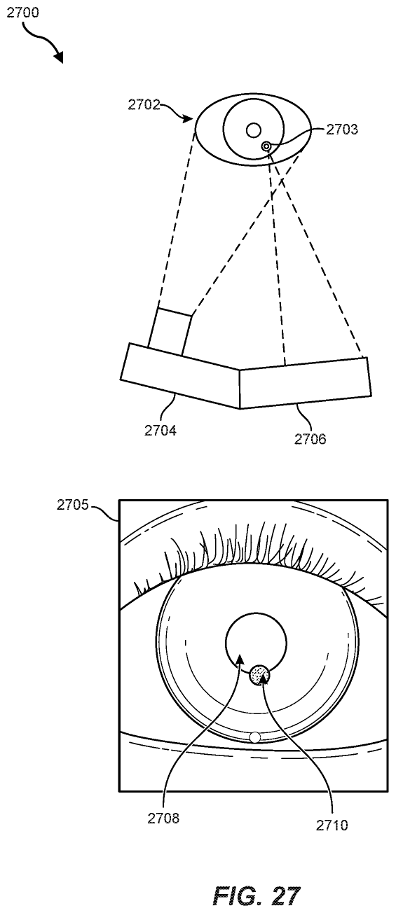

FIG. 27 is a more detailed illustration of various aspects of the eye-tracking subsystem illustrated in FIG. 26. As shown in this figure, an eye-tracking subsystem 2700 may include at least one source 2704 and at least one sensor 2706. Source 2704 generally represents any type or form of element capable of emitting radiation. In one example, source 2704 may generate visible, infrared, and/or near-infrared radiation. In some examples, source 2704 may radiate non-collimated infrared and/or near-infrared portions of the electromagnetic spectrum towards an eye 2702 of a user. Source 2704 may utilize a variety of sampling rates and speeds. For example, the disclosed systems may use sources with higher sampling rates in order to capture fixational eye movements of a user's eye 2702 and/or to correctly measure saccade dynamics of the user's eye 2702. As noted above, any type or form of eye-tracking technique may be used to track the user's eye 2702, including optical-based eye-tracking techniques, ultrasound-based eye-tracking techniques, etc.

Sensor 2706 generally represents any type or form of element capable of detecting radiation, such as radiation reflected off the user's eye 2702. Examples of sensor 2706 include, without limitation, a charge coupled device (CCD), a photodiode array, a complementary metal-oxide-semiconductor (CMOS) based sensor device, and/or the like. In one example, sensor 2706 may represent a sensor having predetermined parameters, including, but not limited to, a dynamic resolution range, linearity, and/or other characteristic selected and/or designed specifically for eye tracking.

As detailed above, eye-tracking subsystem 2700 may generate one or more glints. As detailed above, a glint 2703 may represent reflections of radiation (e.g., infrared radiation from an infrared source, such as source 2704) from the structure of the user's eye. In various embodiments, glint 2703 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 27 shows an example image 2705 captured by an eye-tracking subsystem, such as eye-tracking subsystem 2700. In this example, image 2705 may include both the user's pupil 2708 and a glint 2710 near the same. In some examples, pupil 2708 and/or glint 2710 may be identified using an artificial-intelligence-based algorithm, such as a computer-vision-based algorithm. In one embodiment, image 2705 may represent a single frame in a series of frames that may be analyzed continuously in order to track the eye 2702 of the user. Further, pupil 2708 and/or glint 2710 may be tracked over a period of time to determine a user's gaze.

In one example, eye-tracking subsystem 2700 may be configured to identify and measure the inter-pupillary distance (IPD) of a user. In some embodiments, eye-tracking subsystem 2700 may measure and/or calculate the IPD of the user while the user is wearing the artificial reality system. In these embodiments, eye-tracking subsystem 2700 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 2600 and/or eye-tracking subsystem 2700 may be incorporated into any of the augmented-reality systems in and/or virtual-reality systems described herein in to enable these systems to perform various eye-tracking tasks (including one or more of the eye-tracking operations described herein).

### Example Embodiments

Clause 1: A device, comprising: a waveguide media having opposed outer surfaces; and a plurality of grating elements physically tilted inside the waveguide media such that none of the grating elements are planarly parallel to the opposed outer surfaces of the waveguide media.
Clause 2: The device of clause 1, wherein the plurality of grating elements includes at least one of an incoupler, an outcoupler, or a fold element.
Clause 3: The device of clause 1, wherein the plurality of grating elements includes at least one transmissive grating element.
Clause 4: The device of clause 1, wherein the plurality of grating elements includes at least one reflective grating element.
Clause 5: The device of clause 1, wherein an index of refraction of the waveguide media is no greater than 1.52.
Clause 6: The device of clause 1, wherein an index of refraction of the waveguide media is in a range of 1.5 to 2.7.
Clause 7: The device of clause 1, wherein a waveguide that includes the waveguide media is configured for pupil replication in a head mounted display.
Clause 8: The device of clause 1, wherein a waveguide that includes the waveguide media is configured for infield imaging in a head mounted display.
Clause 9: The device of clause 1, wherein a waveguide that includes the waveguide media achieves a field of view of at least fifty degrees in at least one dimension.
Clause 10: A waveguide, comprising: a waveguide media having opposed outer surfaces; and a plurality of grating elements physically tilted inside the waveguide media such that none of the grating elements are planarly parallel to the opposed outer surfaces of the waveguide media.
Clause 11: The waveguide of clause 10, wherein the plurality of grating elements includes at least one of an incoupler, an outcouplers, or a fold element.
Clause 12: The waveguide of clause 10, wherein the plurality of grating elements includes at least one transmissive grating element.
Clause 13: The waveguide of clause 10, wherein the plurality of grating elements includes at least one reflective grating element.
Clause 14: The waveguide of clause 10, wherein an index of refraction of the waveguide media is no greater than 1.52.
Clause 15: The waveguide of clause 10, wherein an index of refraction of the waveguide media is in a range of 1.5 to 2.7.
Clause 16: A method, comprising: embedding a plurality of grating elements in a waveguide media having opposed outer surfaces, wherein the grating elements are physically tilted inside the waveguide media such that none of the grating elements are planarly parallel to the opposed outer surfaces of the waveguide media; and configuring, in a head mounted display, a waveguide that includes the waveguide media.
Clause 17: The method of clause 16, wherein the waveguide is configured for pupil replication in the head mounted display.
Clause 18: The method of clause 16, wherein the waveguide is configured for infield imaging in the head mounted display.
Clause 19: The method of clause 16, wherein the plurality of grating elements includes at least one transmissive grating element.
Clause 20: The method of clause 16, wherein the plurality of grating elements includes at least one reflective grating element.
Clause 21: An apparatus comprising a backlight unit of a liquid crystal diode display, the backlight unit comprising a pyramid-prism film, the pyramid-prism film comprising a plurality of pyramids disposed on a first surface of the pyramid-prism film and a plurality of prisms disposed on a second surface of the pyramid-prism film opposite the first surface of the pyramid-prism film, wherein a pitch between a first pyramid and a second pyramid in the plurality of pyramids is unequal to a pitch between the first pyramid and a third pyramid.
Clause 22: An apparatus comprising a backlight unit of a liquid crystal diode display, the backlight unit comprising a pyramid-prism film, the pyramid-prism film comprising a plurality of pyramids disposed on a first surface of the pyramid-prism film and a plurality of prisms disposed on a second surface of the pyramid-prism film opposite the first surface of the pyramid-prism film, wherein the plurality of prisms is disposed in curving parallel lines on the second surface of the pyramid-prism film.
Clause 23: A method comprising: providing a backlight unit of a liquid crystal diode display, the backlight unit comprising a pyramid-prism film, the pyramid-prism film comprising a plurality of pyramids disposed on a first surface of the pyramid-prism film and a plurality of prisms disposed on a second surface of the pyramid-prism film opposite the first surface of the pyramid-prism film, wherein a pitch between a first pyramid and a second pyramid in the plurality of pyramids is unequal to a pitch between the first pyramid and a third pyramid.
Clause 24: A method comprising: laminating a clear adhesive layer onto a glass substrate; printing an optical material onto the clear adhesive layer to define an optical structure; curing the optical material to form the optical structure; and stabilizing the optical structure through interaction between the clear adhesive layer and the optical material during or after curing.
Clause 25: A waveguide display comprising: a transparent waveguide configured to guide light from an image source; at least one pupil formed within the transparent waveguide during propagation of the light; and a polarization structure positioned proximal to the transparent waveguide and configured to statically or dynamically control polarization behavior of the light within the transparent waveguide.

### Moiré Pattern Reduction in an LCD Backlight Unit

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

A backlight unit (BLU) for an LCD display used, for example, in an MR headset, includes a stack of elements including a reflector, a light guiding plate (LGP) guiding light (e.g., from an light emitting diode (LED) bar or another light source at one side of the LGP, a pyramid-prism film rotated 98° from a reference line at the LED bar, a bottom brightness enhancement field (BEF) (a sheet of prisms) rotated 98° from a reference line at the LED bar, a matte layer to diffuse light, and a top BEF (a sheet of prisms) rotated 8° from a reference line at the LED bar. The pyramid-prism film guides output light from the LGP to the preferred orientation of top and bottom BEFs, collimating the light beam and enhancing center luminance of the BLU. The pyramid-prism film's current design includes a top surface including pyramids or waffles with fixed pitch and bias angle and a bottom surface including parallel prisms with fixed pitch. Moiré patterns are interference patterns that can be produced when a partially opaque ruled pattern with transparent gaps is overlaid on another similar pattern. In the BLU, interference between the ridge line of pyramids or waffles and the prism layer underneath can cause a moiré pattern, affecting a user's visual experience and degrading the display image quality. This is particularly apparent when an LCD using such a backlight design is used in an MR headset including a magnifying lens, as the lens also magnifies the moiré pattern. Thus, there is a need to reduce moiré patterns in an LCD backlight unit.

Embodiments of the present disclosure address the above identified problems by implementing moiré pattern reduction in a prism-pyramid film of an LCD backlight unit. Embodiments include a first surface (referred to herein as a top surface but need not be on top) with inter-pyramid pitch adjustments and a second surface parallel to the first surface (referred to herein as a bottom surface but need not be on the bottom) with inter-prism pitch adjustments. In embodiments, both the first and second surfaces include one or more of pyramids, waffles, dots, cylinders, prisms, and the like. In addition, where descriptions herein refer to pyramids or prisms other structures such as pyramids, prisms, waffles, dots, cylinders, and the like are also included. In embodiments, the optical refractive index of the first and second surfaces ranges from 1.4 to 1.8. The prism-pyramid film can be fabricated using diamond tuning, V-cut, laser gray scale writing, and other presently available techniques.

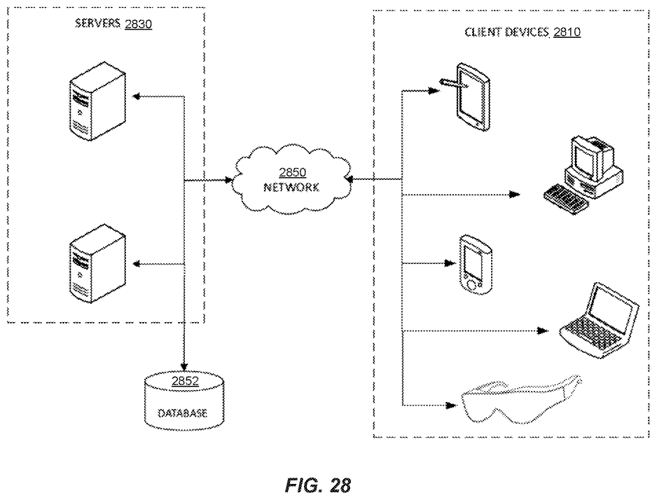

FIG. 28 illustrates a network architecture used to communicate with a system incorporating moiré pattern reduction in an LCD backlight unit, according to some embodiments. The network architecture 2800 may include one or more client devices 2810 and servers 2830, communicatively coupled via a network 2850 with each other and to at least one database 2852. Database 2852 may store data and files associated with the servers 2830 and/or the client devices 2810. In some embodiments, client devices 2810 collect data, video, images, and the like, for upload to the servers 130 to store in the database 2852.

The network 2850 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 2850 may further include one or more of a local area network (LAN), a wide area network (WAN), the Internet, and the like. Further, the network 2850 may include, but is not limited to, any one or more of the following network topologies, including a bus network, a star network, a ring network, a mesh network, and the like.

Client devices 2810 may include, but are not limited to, laptop computers, desktop computers, and mobile devices such as smart phones, tablets, televisions, wearable devices, head-mounted devices, display devices, and the like.

In some embodiments, the servers 2830 may be a cloud server or a group of cloud servers. In other embodiments, some or all of the servers 2830 may not be cloud-based servers (i.e., may be implemented outside of a cloud computing environment, including but not limited to an on-premises environment), or may be partially cloud-based. Some or all of the servers 2830 may be part of a cloud computing server, including but not limited to rack-mounted computing devices and panels. Such panels may include but are not limited to processing boards, switchboards, routers, and other network devices. In some embodiments, the servers 2830 may include the client devices 2810 as well, such that they are peers.

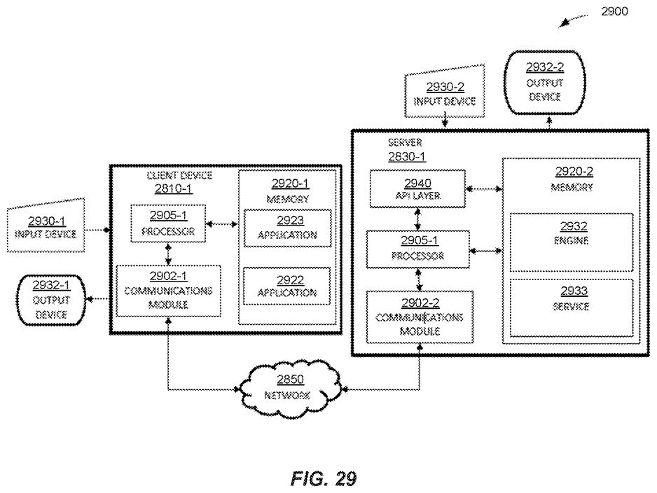

FIG. 29 is a block diagram illustrating details of a system 2900 including a display incorporating moiré pattern reduction in an LCD backlight unit, according to some embodiments. Specifically, the example of FIG. 29 illustrates an exemplary client device 2810-1 (of the client devices 2810) and an exemplary server 2830-1 (of the servers 2830) in the network architecture 2800 of FIG. 28.

Client device 2810-1 and server 2830-1 are communicatively coupled over network 2850 via respective communications modules 2902-1 and 2902-2 (hereinafter, collectively referred to as “communications modules 2902”). Communications modules 2902 are configured to interface with network 2850 to send and receive information, such as requests, data, messages, commands, and the like, to other devices on the network 2850. Communications modules 2902 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 2810-1 and server 2830-1 also include a processor 2905-1, 2905-2 and memory 2920-1, 2920-2, respectively. Processors 2905-1 and 2905-2, and memories 2920-1 and 220-2 will be collectively referred to, hereinafter, as “processors 2905,” and “memories 2920.” Processors 2905 may be configured to execute instructions stored in memories 2920, to cause client device 2810-1 and/or server 2830-1 to perform methods and operations consistent with embodiments of the present disclosure.

The client device 2810-1 and the server 2830-1 are each coupled to at least one input device 2930-1 and input device 2930-2, respectively (hereinafter, collectively referred to as “input devices 2930”). The input devices 2930 can include a mouse, a controller, a keyboard, a pointer, a stylus, a touchscreen, a microphone, voice recognition software, a joystick, a virtual joystick, a touch-screen display, and the like. In some embodiments, the input devices 2930 may include cameras, microphones, sensors, and the like. In some embodiments, the sensors may include touch sensors, acoustic sensors, inertial motion units and the like.

The client device 2810-1 and the server 2830-1 are also coupled to at least one output device 232-1 and output device 2932-2, respectively (hereinafter, collectively referred to as “output devices 2932”). The output devices 2932 may include a screen, a display (e.g., a same touchscreen display used as an input device), a speaker, an alarm, and the like. A user may interact with client device 2810-1 and/or server 2830-1 via the input devices 2930 and the output devices 2932.

Memory 2920-1 may further include an application 2922, configured to execute on client device 2810-1 and couple with input device 2930-1 and output device 2932-1, and implement moiré pattern reduction in an LCD backlight unit. The application 2922 may be downloaded by the user from server 2830-1, and/or may be hosted by server 2830-1. The application 2922 may include specific instructions which, when executed by processor 2905-1, cause operations to be performed consistent with embodiments of the present disclosure. In some embodiments, the application 2922 runs on an operating system (OS) installed in client device 2810-1. In some embodiments, application 2922 may run within a web browser. In some embodiments, the processor 2905-1 is configured to control a graphical user interface (GUI) (e.g., spanning at least a portion of input devices 2930 and output devices 2932) for the user of client device 2810-1 to access the server 2830-1.

In some embodiments, memory 2920-2 includes an application engine 2932. The application engine 2932 may be configured to perform methods and operations consistent with embodiments of the present disclosure. The application engine 2932 may share or provide features and resources with the client device 2810-1, including data, libraries, and/or applications retrieved with application engine 2932 (e.g., application 2922). The user may access the application engine 2932 through the application 2922. The application 2922 may be installed in client device 2810-1 by the application engine 2932 and/or may execute scripts, routines, programs, applications, and the like provided by the application engine 2932.

Memory 2920-1 may further include an application 2923, configured to execute in client device 2810-1. The application 2923 may communicate with service 2933 in memory 2920-2 to provide moiré pattern reduction in an LCD backlight unit. The application 2923 may communicate with service 2933 through API layer 2940, for example.

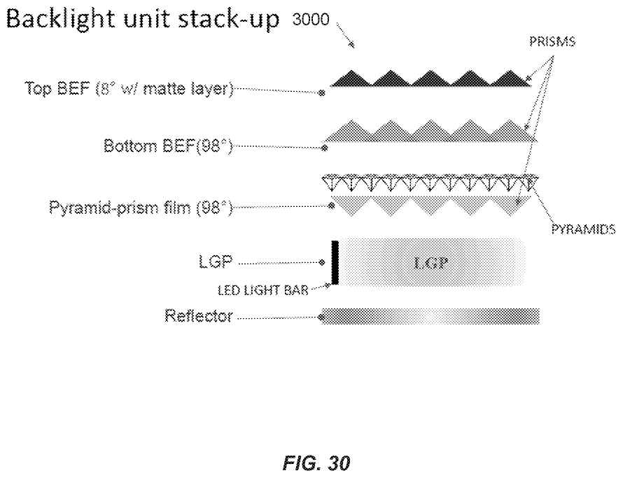

FIG. 30 depicts portions of an LCD backlight unit, in accordance with an illustrative embodiment.

A backlight unit (BLU) for an LCD display used, for example, in an MR headset, includes backlight unit stack-up 3000: a stack of elements including a reflector, a light guiding plate (LGP) guiding light (e.g., from an light emitting diode (LED) bar or another light source at one side of the LGP, a pyramid-prism film rotated 98° from a reference line at the LED bar, a bottom brightness enhancement field (BEF) (a sheet of prisms) rotated 98° from a reference line at the LED bar, a matte layer to diffuse light, and a top BEF (a sheet of prisms) rotated 8° from a reference line at the LED bar.

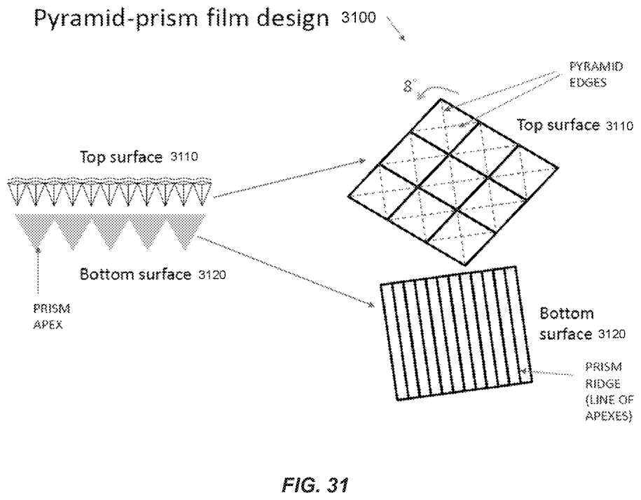

FIG. 31 depicts additional detail of a pyramid-prism film 3100 used in an LCD backlight unit, in accordance with an illustrative embodiment. As prisms on one surface of the pyramid-prism film (e.g., bottom surface 3120) are arranged in a grid, lines of prism apexes form ridges. Dotted lines on the opposite surface of the pyramid-prism film (e.g., top surface 3110) represent pyramid edges. Interference between the ridge line of pyramids or waffles and the prism layer underneath can cause a moiré pattern.

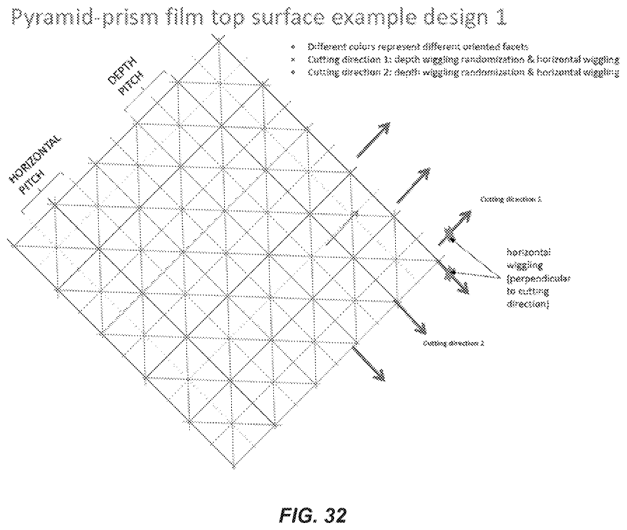

FIG. 32 depicts an example of moiré pattern reduction in an LCD backlight unit, in accordance with an illustrative embodiment.

In particular, FIG. 32 depicts a top view of a top surface of a pyramid-prism film. Solid blue lines represent boundaries of individual pyramids, and the distance between two adjacent parallel solid blue lines is referred to as the depth pitch. Solid red lines represent individual pyramid edges. Dotted red lines are not visible but represent pyramid geometry. In particular, the distance between two adjacent parallel dotted red lines is referred to as the horizontal pitch. In the depicted design, cutting along depicted cutting direction 1 or 2 includes depth wiggling randomization, i.e., removing a random amount of depth of material from a line separating two adjacent lines of pyramids and horizontal wiggling (i.e., varying the cutting line perpendicularly to the cutting direction. The material removed alters horizontal and depth pitch between pyramids in the film, removing the periodicity causing a moiré pattern.

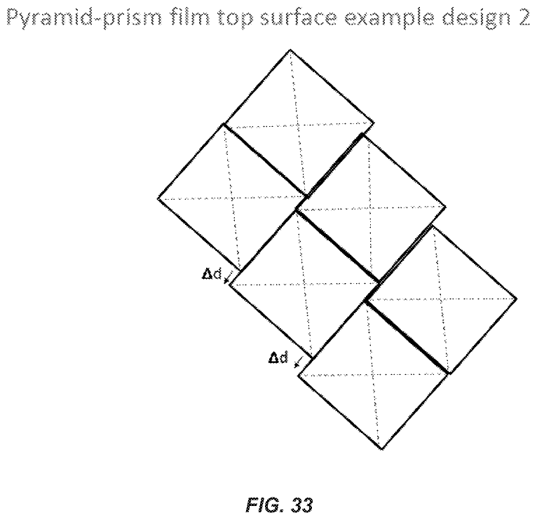

FIG. 33 depicts another example of moiré pattern reduction in an LCD backlight unit, in accordance with an illustrative embodiment.

In particular, FIG. 33 depicts a top view of a pyramid-prism film in which a line of pyramids is shifted horizontally relative to an adjacent line of pyramids by a constant distance denoted by Δd, altering pitch between pyramids in the film and removing the periodicity causing a moiré pattern.

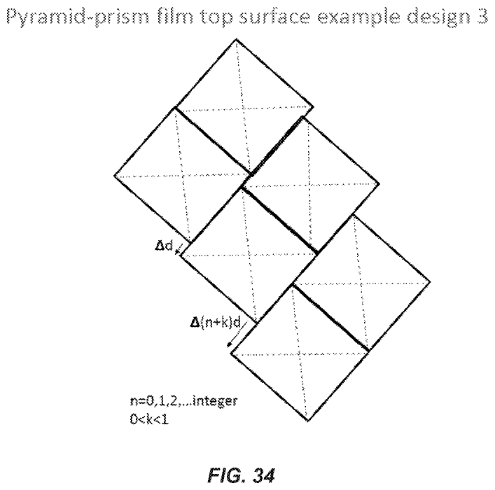

FIG. 34 depicts another example of moiré pattern reduction in an LCD backlight unit, in accordance with an illustrative embodiment.

In particular, FIG. 34 depicts a top view of a pyramid-prism film in which a line of pyramids is shifted horizontally relative to an adjacent line of pyramids by an increasing distance denoted by Δ(n+k)d, altering pitch between pyramids in the film and removing the periodicity causing a moiré pattern.

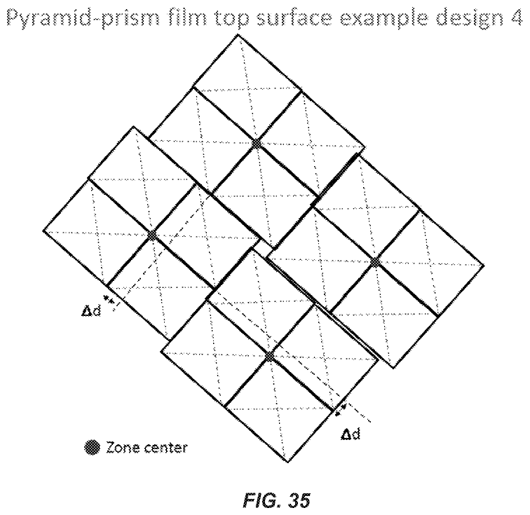

FIG. 35 depicts another example of moiré pattern reduction in an LCD backlight unit, in accordance with an illustrative embodiment.

In particular, FIG. 35 depicts a top view of a pyramid-prism film in which groups, or zones, of pyramids are defined. Although as depicted there are four pyramids in a zone, a zone can include more or fewer pyramids. A zone center indicates the center of each zone. Zones are shifted relative to other zones by moving each zone center a constant distance denoted by Δd, altering pitch between pyramids in the film and removing the periodicity causing a moiré pattern.

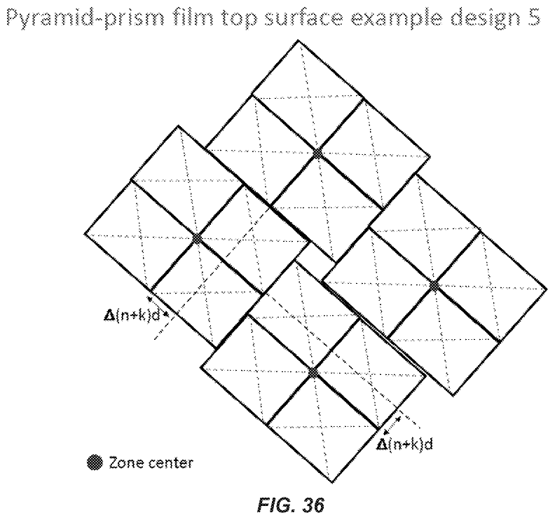

FIG. 36 depicts another example of moiré pattern reduction in an LCD backlight unit, in accordance with an illustrative embodiment.

In particular, FIG. 36 depicts a top view of a pyramid-prism film in which groups, or zones, of pyramids are defined. Although as depicted there are four pyramids in a zone, a zone can include more or fewer pyramids. A zone center indicates the center of each zone. Zones are shifted relative to other zones by moving each zone center an increasing distance denoted by Δ(n+k)d, altering pitch between pyramids in the film and removing the periodicity causing a moiré pattern.

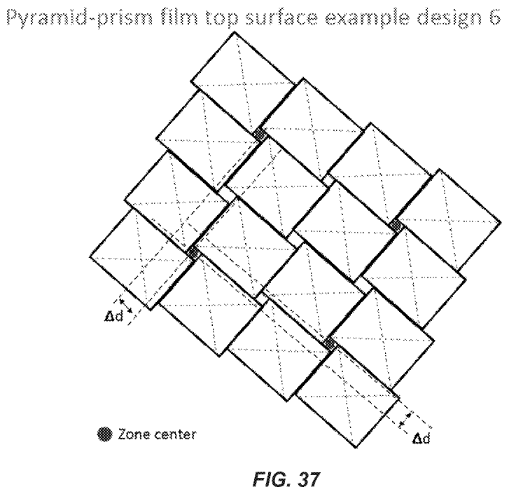

FIG. 37 depicts another example of moiré pattern reduction in an LCD backlight unit, in accordance with an illustrative embodiment.

In particular, FIG. 37 depicts a top view of a pyramid-prism film in which groups, or zones, of pyramids are defined. Although as depicted there are four pyramids in a zone, a zone can include more or fewer pyramids. A zone center indicates the center of each zone. Zones are shifted relative to other zones by moving each zone center a constant distance denoted by Δd and individual pyramids within a zone are shifted a constant distance denoted by Δd, altering pitch between pyramids in the film and removing the periodicity causing a moiré pattern.

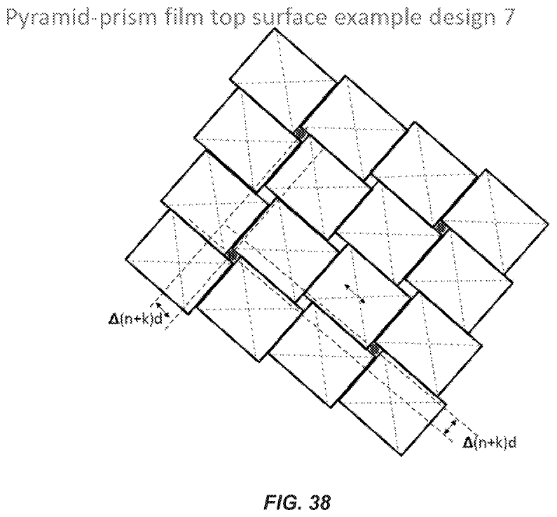

FIG. 38 depicts another example of moiré pattern reduction in an LCD backlight unit, in accordance with an illustrative embodiment.

In particular, FIG. 38 depicts a top view of a pyramid-prism film in which groups, or zones, of pyramids are defined. Although as depicted there are four pyramids in a zone, a zone can include more or fewer pyramids. A zone center indicates the center of each zone. Zones are shifted relative to other zones by moving each zone center an increasing distance denoted by Δ(n+k)d and individual pyramids within a zone are shifted an increasing distance denoted by Δ(n+k)d, altering pitch between pyramids in the film and removing the periodicity causing a moiré pattern.

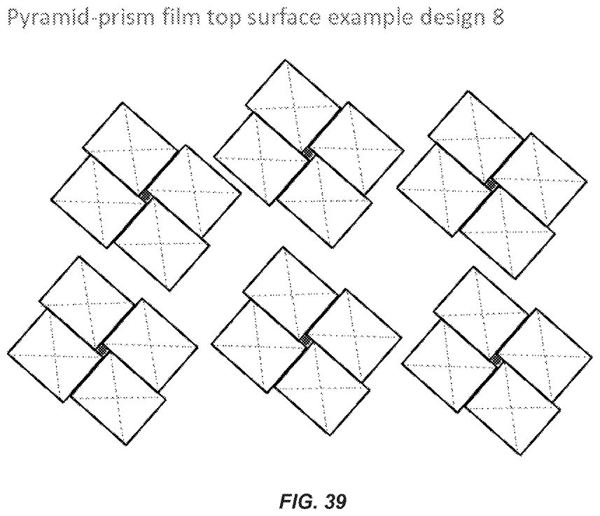

FIG. 39 depicts another example of moiré pattern reduction in an LCD backlight unit, in accordance with an illustrative embodiment.

In particular, FIG. 39 depicts a top view of a pyramid-prism film in which groups, or zones, of pyramids are defined. Although as depicted there are four pyramids in a zone, a zone can include more or fewer pyramids. A zone center indicates the center of each zone. Zones are shifted relative to other zones by moving each zone center a random distance (e.g., generated using a pseudorandom number generator, a presently available technique), altering pitch between pyramids in the film and removing the periodicity causing a moiré pattern.

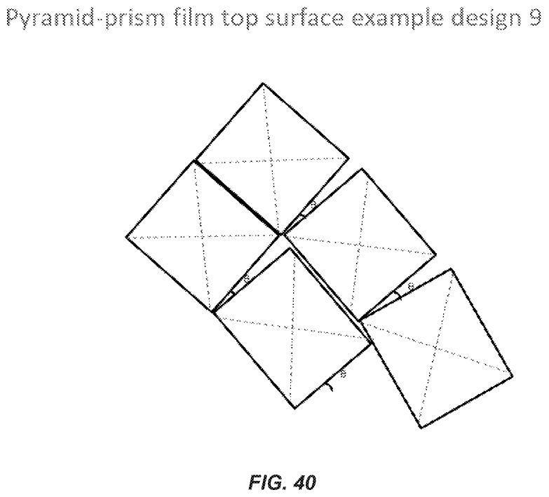

FIG. 40 depicts another example of moiré pattern reduction in an LCD backlight unit, in accordance with an illustrative embodiment.

In particular, FIG. 40 depicts a top view of a pyramid-prism film in which an individual pyramid is rotated relative to an adjacent pyramid by a constant angle denoted by θ, altering pitch between pyramids in the film and removing the periodicity causing a moiré pattern.

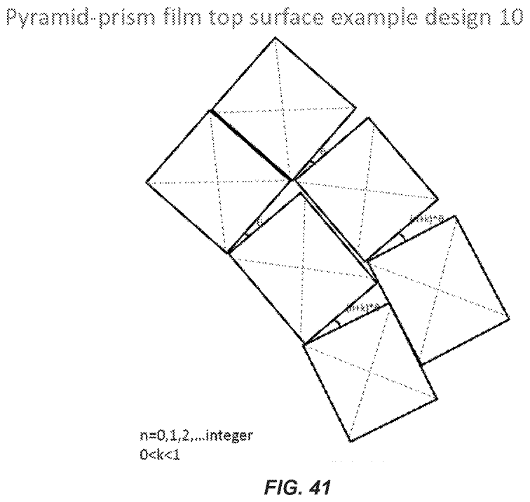

FIG. 41 depicts another example of moiré pattern reduction in an LCD backlight unit, in accordance with an illustrative embodiment.

In particular, FIG. 41 depicts a top view of a pyramid-prism film in which an individual pyramid is rotated relative to an adjacent pyramid by an increasing angle denoted by (n+k)θ, altering pitch between pyramids in the film and removing the periodicity causing a moiré pattern.

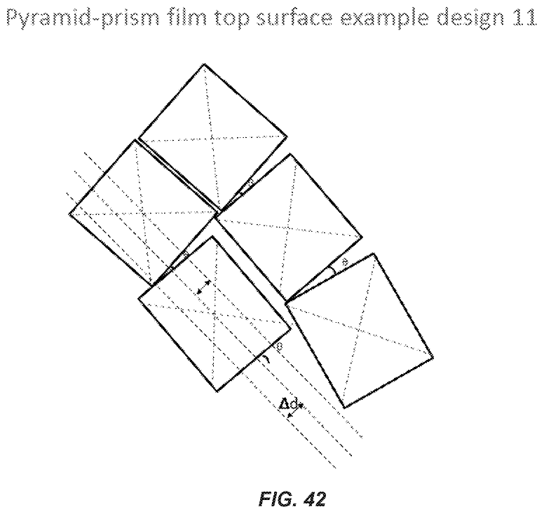

FIG. 42 depicts another example of moiré pattern reduction in an LCD backlight unit, in accordance with an illustrative embodiment.

In particular, FIG. 42 depicts a top view of a pyramid-prism film in which an individual pyramid is rotated relative to an adjacent pyramid by a constant angle denoted by θ, and shifted horizontally by a constant distance denoted by Δd, altering pitch between pyramids in the film and removing the periodicity causing a moiré pattern.

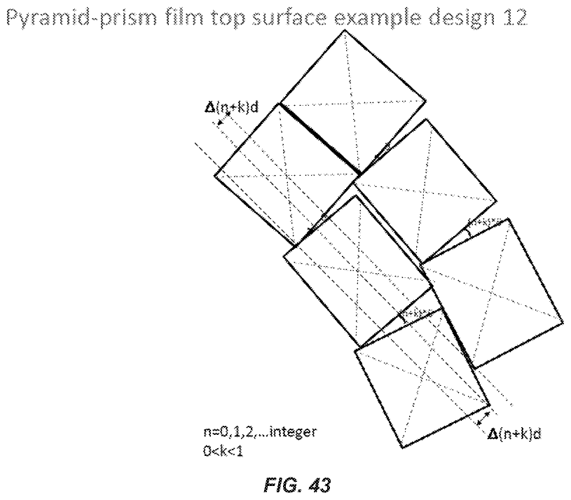

FIG. 43 depicts another example of moiré pattern reduction in an LCD backlight unit, in accordance with an illustrative embodiment.

In particular, FIG. 43 depicts a top view of a pyramid-prism film in which an individual pyramid is rotated relative to an adjacent pyramid by an increasing angle denoted by (n+k)θ, and shifted horizontally by an increasing distance denoted by Δ(n+k)d, altering pitch between pyramids in the film and removing the periodicity causing a moiré pattern.

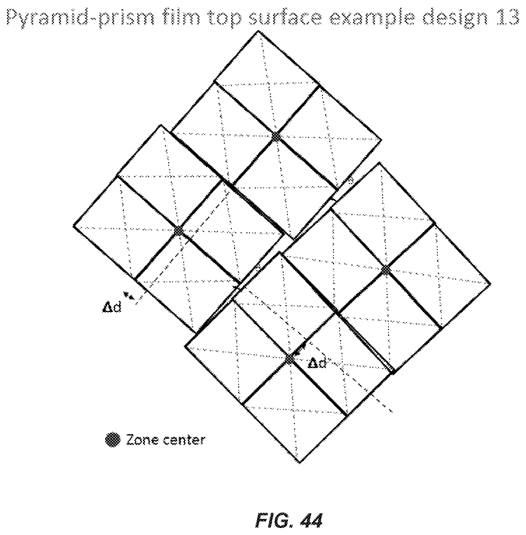

FIG. 44 depicts another example of moiré pattern reduction in an LCD backlight unit, in accordance with an illustrative embodiment.

In particular, FIG. 44 depicts a top view of a pyramid-prism film in which groups, or zones, of pyramids are defined. Although as depicted there are four pyramids in a zone, a zone can include more or fewer pyramids. A zone center indicates the center of each zone. Zones are shifted relative to other zones by rotating each zone center relative to an adjacent zone center by a constant angle denoted by θ and shifted horizontally by a constant distance denoted by Δd, altering pitch between pyramids in the film and removing the periodicity causing a moiré pattern.

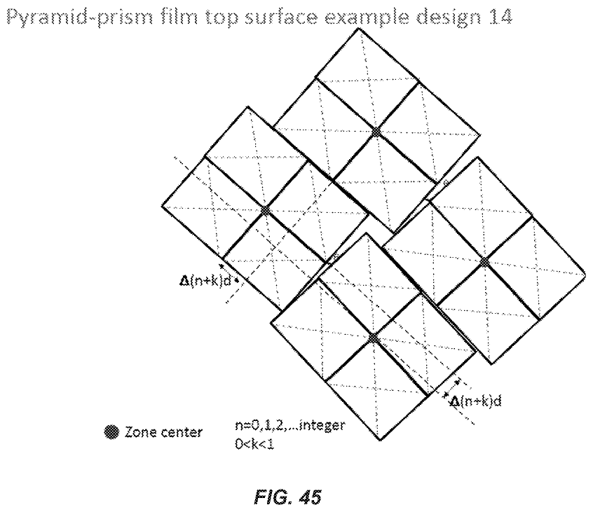

FIG. 45 depicts another example of moiré pattern reduction in an LCD backlight unit, in accordance with an illustrative embodiment.

In particular, FIG. 45 depicts a top view of a pyramid-prism film in which groups, or zones, of pyramids are defined. Although as depicted there are four pyramids in a zone, a zone can include more or fewer pyramids. A zone center indicates the center of each zone. Zones are shifted relative to other zones by rotating each zone center relative to an adjacent zone center by a constant angle denoted by θ and shifted horizontally by an increasing distance denoted by Δ(n+k)d, altering pitch between pyramids in the film and removing the periodicity causing a moiré pattern.

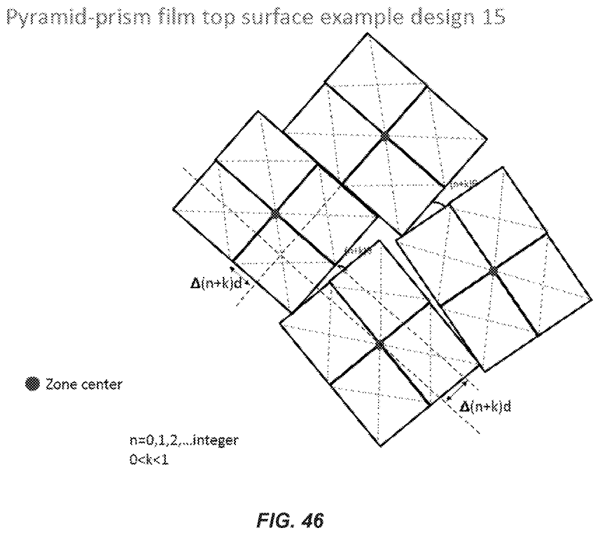

FIG. 46 depicts another example of moiré pattern reduction in an LCD backlight unit, in accordance with an illustrative embodiment.

In particular, FIG. 46 depicts a top view of a pyramid-prism film in which groups, or zones, of pyramids are defined. Although as depicted there are four pyramids in a zone, a zone can include more or fewer pyramids. A zone center indicates the center of each zone. Zones are shifted relative to other zones by rotating each zone center relative to an adjacent zone center by an increasing angle denoted by (n+k)θ and shifted horizontally by an increasing distance denoted by Δ(n+k)d, altering pitch between pyramids in the film and removing the periodicity causing a moiré pattern.

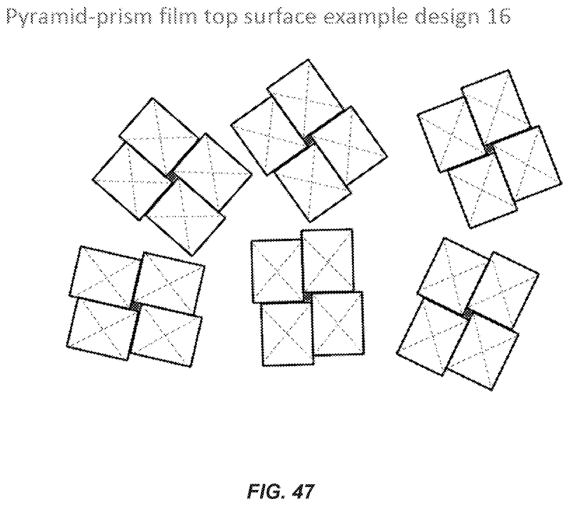

FIG. 47 depicts another example of moiré pattern reduction in an LCD backlight unit, in accordance with an illustrative embodiment.

In particular, FIG. 47 depicts a top view of a pyramid-prism film in which groups, or zones, of pyramids are defined. Although as depicted there are four pyramids in a zone, a zone can include more or fewer pyramids. A zone center indicates the center of each zone. Zones are shifted relative to other zones by moving each zone center a random distance (e.g., generated using a pseudorandom number generator, a presently available technique) and by rotating each zone center relative to an adjacent zone center by a random angle, altering pitch between pyramids in the film and removing the periodicity causing a moiré pattern.

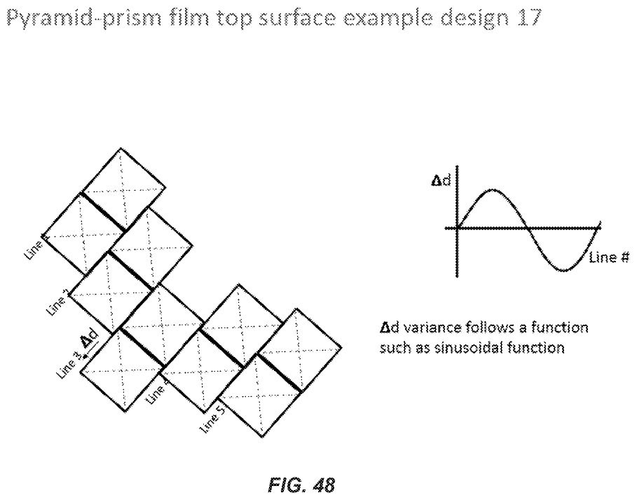

FIG. 48 depicts another example of moiré pattern reduction in an LCD backlight unit, in accordance with an illustrative embodiment.

In particular, FIG. 48 depicts a top view of a pyramid-prism film in which a line of pyramids is shifted horizontally relative to an adjacent line of pyramids by an varying distance denoted by Δd, where Δd for a line is determined by a function such as a sinusoidal function, altering pitch between pyramids in the film and removing the periodicity causing a moiré pattern.

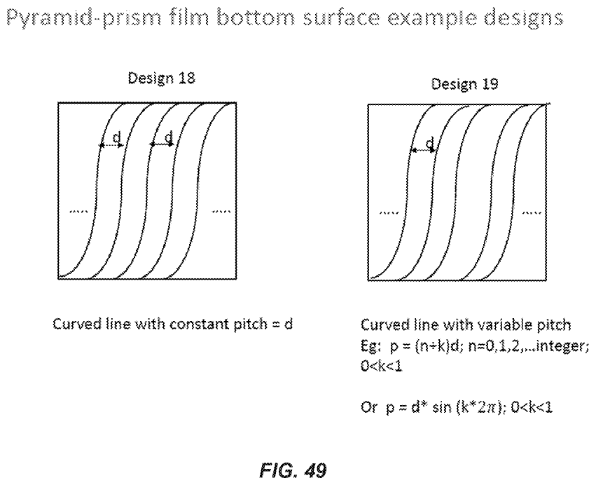

FIG. 49 depicts another example of moiré pattern reduction in an LCD backlight unit, in accordance with an illustrative embodiment.

In particular, FIG. 49 depicts designs for a bottom of a pyramid-prism film in which lines of prisms are disposed in adjacent curved lines and each line of prisms pyramids is shifted relative to an adjacent line by a constant or an varying distance, altering pitch between prisms in the film and removing the periodicity causing a moiré pattern.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

The accompanying appendix, which is included to provide further understanding of the subject technology and is incorporated in and constitutes a part of this specification, illustrates aspects of the subject technology and together with the description serves to explain the principles of the subject technology.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims or clauses, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims or clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims or clauses may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

### Systems and Methods for Improved Fabrication of Transparent Optical Lenses

In some aspects, the techniques described herein relate to a method including: laminating a clear adhesive layer onto a glass substrate; printing an optical material onto the clear adhesive layer to define an optical structure; curing the optical material to form the optical structure; and stabilizing the optical structure through interaction between the clear adhesive layer and the optical material during or after curing.

During additive manufacturing of optical structures, such as optical lenses (e.g., ophthalmic lenses), through three-dimensional (3D) printing of optical materials onto transparent substrates (e.g., glass), deformation is often observed as a result of volumetric shrinkage of printed resin and mismatch in coefficients of thermal expansion (CTE) between the glass and the printed material. Such deformation leads to loss of surface flatness and deviation from optical feature specifications. Conventional approaches may attempt to mitigate these effects by printing intermediate buffer layers or by applying optical clear adhesives (OCA) after printing to bond components of differing CTE. However, these methods frequently require additional lamination pressure or autoclave treatment to eliminate air bubbles and ensure adhesion. Conducting additional processing steps add complexity, time, and cost to the manufacturing workflow, while still not fully eliminating deformation-related defects.

The present disclosure is generally directed to a method for fabricating optical lenses with reduced deformation and improved surface flatness by utilizing a pre-laminated OCA layer on a transparent substrate prior to 3D printing. This approach may include an OCA that is first laminated onto the glass substrate to form an optically transparent layer. The OCA may compensate for differences in CTE between the glass substrate and the printed optical material, while absorbing stresses resulting from volumetric shrinkage during the curing process.

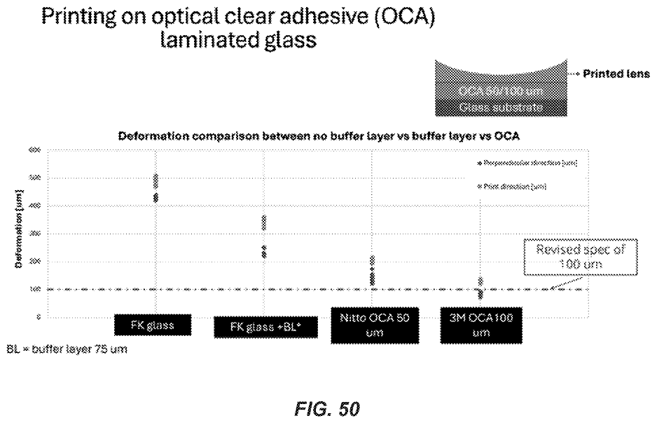

In one example, the glass substrate may be laminated with an OCA. In some examples, an optical material, such as an ultraviolet-curable or thermally curable optical resin, may be directly printed on at least a portion of a surface of the OCA. In some examples, the adhesive layer may facilitate adhesion between the printed optical structure and the glass substrate without requiring external pressure or post-processing in an autoclave. For example, the OCA may interact with the optical material to stabilize the printed lens and preserve the flatness of the substrate. In some examples, FIG. 50 depicts an example of an optical clear adhesive chart, in accordance with an illustrative embodiment.

In further examples, the OCA layer may be applied using additional methods including but not limited to spraying and/or screen printing that deposit an optically clear layer on a substrate. The adhesive may be selected based on optical elements including, but not limited to optical clarity, refractive index matching, and mechanical compliance. In some examples, the approach disclosed herein may ensure compatibility with both the substrate and the printed optical adhesive. By introducing a laminated adhesive, deformation induced by thermal stress may be reduced. Additionally, the fabrication of the disclosed optical lenses may include an improved optical geometry without pressure-assisted lamination or bubble-removal processes.

### Systems and Methods for Improved Attenuation of Interference in Optical Waveguides

In some aspects, the techniques described herein relate to a waveguide display comprising: a transparent waveguide configured to guide light from an image source, at least one pupil formed within the transparent waveguide during propagation of the light, and a polarization structure positioned proximal to the transparent waveguide and configured to statically or dynamically control polarization behavior of the light within the transparent waveguide.

In waveguide-based augmented reality displays, light from an image source is guided through a transparent waveguide and replicated to form multiple pupils. In some cases, when the waveguide is made of an anisotropic material, the light may split into different polarization states that travel at different angles within the waveguide. As these replicated pupils continue to form and propagate through the waveguide, the separation between the polarization states may cause the pupils to become offset in position and phase. This offset creates regular interference patterns across the field of view, which may reduce image uniformity and degrade the viewing experience. Existing approaches do not adequately prevent this polarization-based splitting of replicated pupils and therefore do not resolve the resulting interference.

The present disclosure is generally directed to a system including waveguide display configured to address a polarization induced separation of pupil replicas by incorporating a polarization structure positioned proximally to the transparent waveguide. In some examples, the polarization structure is configured to dynamically control polarization behavior of light as it propagates within the waveguide. By influencing polarization states during pupil replication, the polarization structure may reduce the flow of optical power between ordinary and extraordinary polarization components produced by anisotropic substrate materials such as silicon carbide or lithium niobate. Influencing polarization states in this manner may prevent the generation of a problematic pattern of replicated pupils that would otherwise lead to the observed interference patterns across the display field of view.

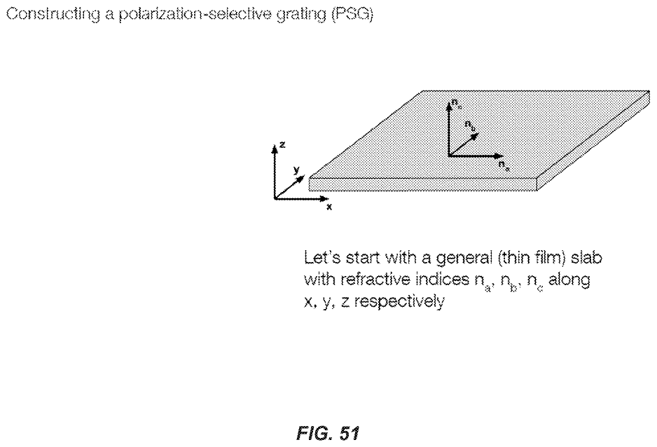

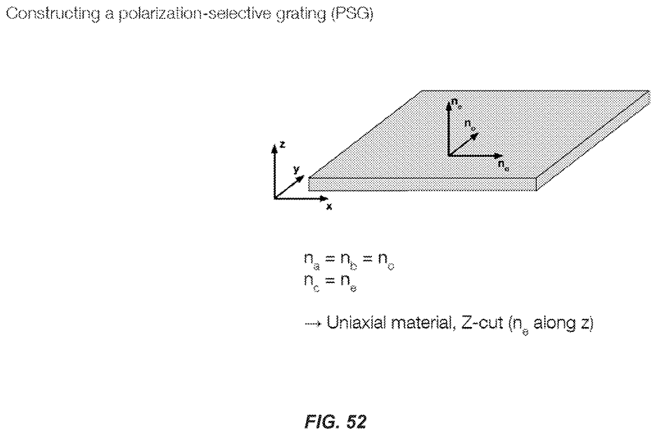

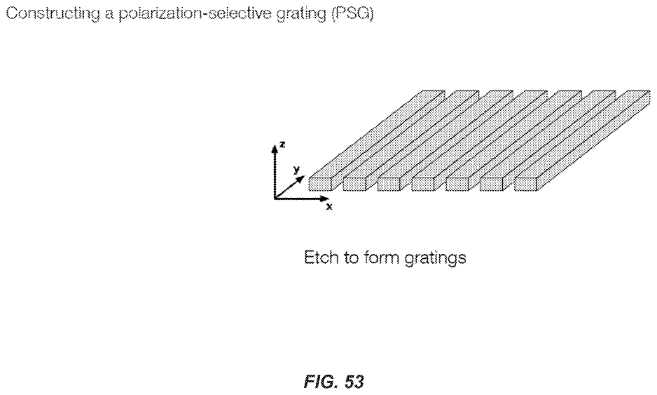

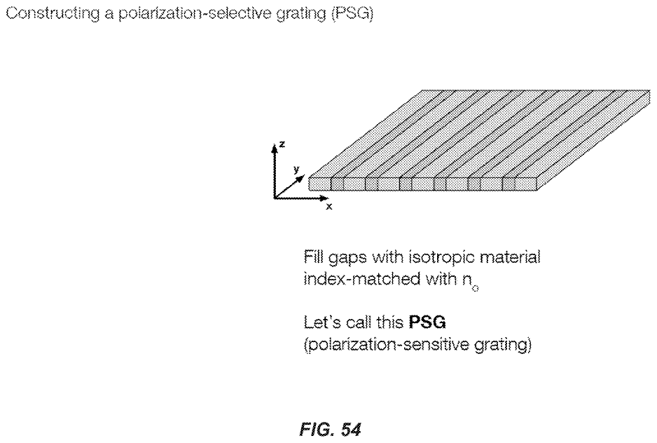

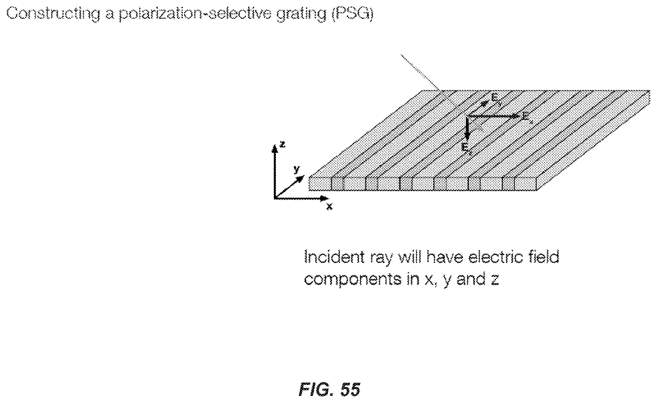

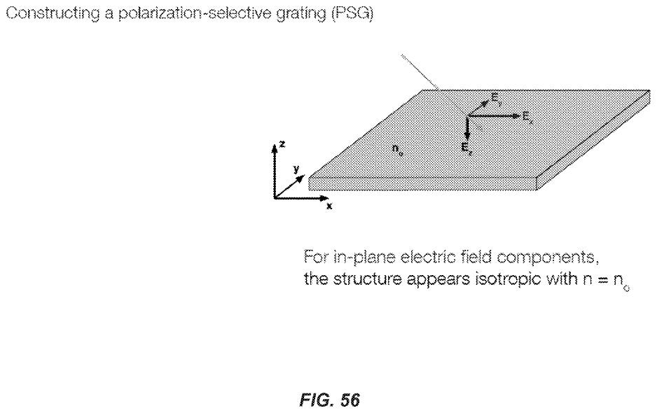

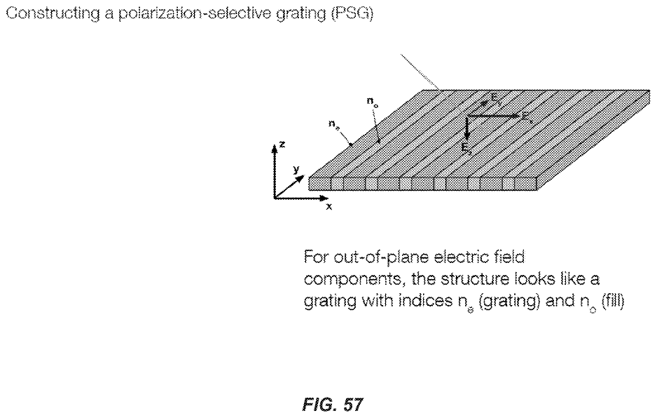

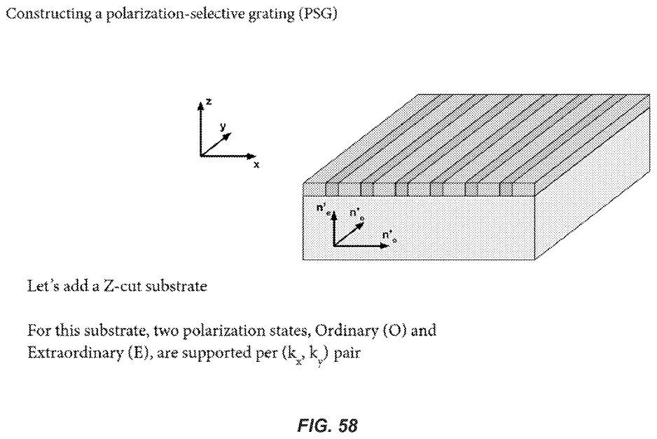

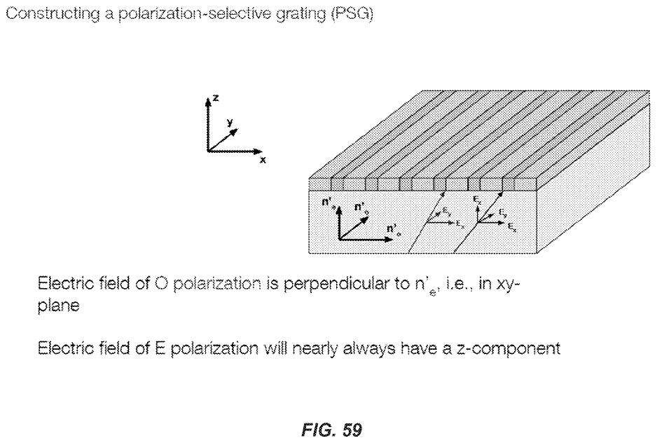

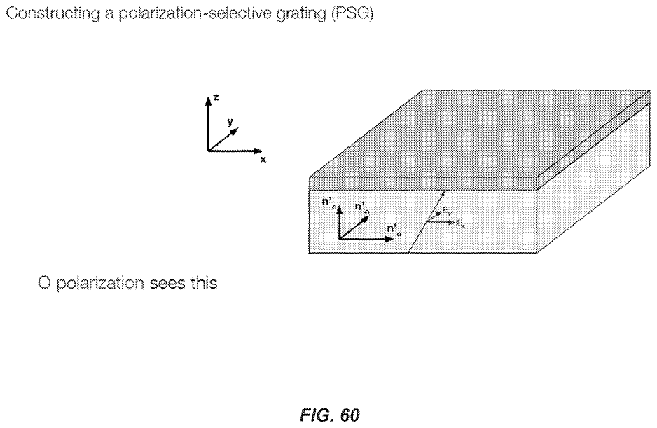

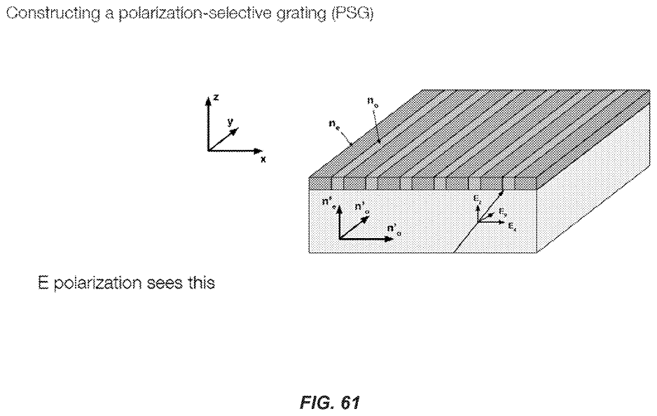

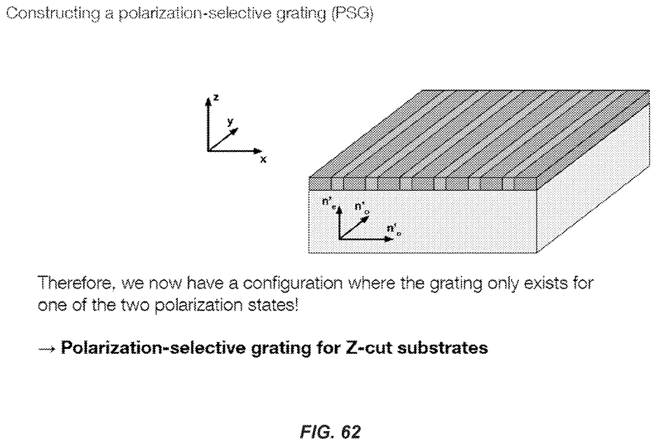

In one example, light from an image source may be coupled into the transparent waveguide and replicated to form at least one pupil within the waveguide. The pupil replication may be performed by any suitable optical coupling structure embedded in or on the waveguide, such as diffraction gratings. As light propagates and undergoes repeated pupil replication at the interface of such gratings, anisotropy of the waveguide may cause the light to split into polarization states that follow distinct propagation angles. A polarization structure may be positioned on, in, and/or near the waveguide to control polarization behavior of the light during this process. In some examples, the polarization structure may be configured to reduce polarization driven separation of replicated pupils, preserving their respective alignment in space and phase as they propagate. In some examples, FIG. 51 depicts an example of a polarization-selective grating, in accordance with embodiments of the present disclosure. In some examples FIGS. 52-62 depict other examples of polarization-selective gratings, in accordance with embodiments of the present disclosure.

In some examples, the polarization structure may be integrated directly into one or more diffraction gratings used for various methods including in-coupling, pupil replication, or out-coupling within the waveguide. The grating may be configured to selectively diffract at least one polarization state while allowing a different polarization state to continue propagating through the waveguide with minimal or no diffraction by reducing or eliminating refractive index modulation for that polarization. In some examples, the grating may be implemented as a static structure with a fixed birefringent or anisotropic pattern. In other examples, the grating may be implemented in an active structure that is dynamically adjustable. The active structure may include a refractive index profile or phase pattern that is modified via various methods including electrically, optically, thermally, or through material state change to adjust polarization interaction during propagation.

In further examples, the polarization structure may be implemented using various materials or material combinations configured to influence polarization behavior of light within the waveguide. The polarization structure may include materials including, but not limited to, naturally birefringent materials, crystalline substrates, and/or artificial birefringent materials. In some examples, the polarization structure may further comprise two-dimensional (2D) materials or stacked 2D material assemblies. In other examples, artificial birefringence may be created by layering materials with differing electromagnetic properties or by patterning a material in plane to produce anisotropic optical behavior. These materials or structures may be selected to interact with polarization states during pupil replication while remaining compatible with the high refractive index and anisotropic properties of the waveguide substrate. In additional examples, the polarization structure may include an active layer comprising liquid crystal material. The liquid crystal layer may be addressable and configured to modify birefringence. By dynamically altering polarization states of light during propagation and pupil replication within the waveguide, the liquid crystal structure may reduce polarization induced angular divergence and phase separation between replicated pupils.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A device, comprising:
a waveguide media having opposed outer surfaces; and
a plurality of grating elements physically tilted inside the waveguide media such that none of the grating elements are planarly parallel to the opposed outer surfaces of the waveguide media.

2. The device of claim 1, wherein the plurality of grating elements includes at least one of an incoupler, an outcoupler, or a fold element.

3. The device of claim 1, wherein the plurality of grating elements includes at least one transmissive grating element.

4. The device of claim 1, wherein the plurality of grating elements includes at least one reflective grating element.

5. The device of claim 1, wherein an index of refraction of the waveguide media is no greater than 1.52.

6. The device of claim 1, wherein an index of refraction of the waveguide media is in a range of 1.5 to 2.7.

7. The device of claim 1, wherein a waveguide that includes the waveguide media is configured for pupil replication in a head mounted display.

8. The device of claim 1, wherein a waveguide that includes the waveguide media is configured for infield imaging in a head mounted display.

9. The device of claim 1, wherein a waveguide that includes the waveguide media achieves a field of view of at least fifty degrees in at least one dimension.

10. A waveguide, comprising:
a waveguide media having opposed outer surfaces; and
a plurality of grating elements physically tilted inside the waveguide media such that none of the grating elements are planarly parallel to the opposed outer surfaces of the waveguide media.

11. The waveguide of claim 10, wherein the plurality of grating elements includes at least one of an incoupler, an outcouplers, or a fold element.

12. The waveguide of claim 10, wherein the plurality of grating elements includes at least one transmissive grating element.

13. The waveguide of claim 10, wherein the plurality of grating elements includes at least one reflective grating element.

14. The waveguide of claim 10, wherein an index of refraction of the waveguide media is no greater than 1.52.

15. The waveguide of claim 10, wherein an index of refraction of the waveguide media is in a range of 1.5 to 2.7.

16. A method, comprising:
embedding a plurality of grating elements in a waveguide media having opposed outer surfaces, wherein the grating elements are physically tilted inside the waveguide media such that none of the grating elements are planarly parallel to the opposed outer surfaces of the waveguide media; and
configuring, in a head mounted display, a waveguide that includes the waveguide media.

17. The method of claim 16, wherein the waveguide is configured for pupil replication in the head mounted display.

18. The method of claim 16, wherein the waveguide is configured for infield imaging in the head mounted display.

19. An apparatus comprising:
a backlight unit of a liquid crystal diode display, the backlight unit comprising a pyramid-prism film;
the pyramid-prism film comprising a plurality of pyramids disposed on a first surface of the pyramid-prism film; and
a plurality of prisms disposed on a second surface of the pyramid-prism film opposite the first surface of the pyramid-prism film, wherein a pitch between a first pyramid and a second pyramid in the plurality of pyramids is unequal to a pitch between the first pyramid and a third pyramid.

20. A method comprising:
laminating a clear adhesive layer onto a glass substrate;
printing an optical material onto the clear adhesive layer to define an optical structure;
curing the optical material to form the optical structure; and
stabilizing the optical structure through interaction between the clear adhesive layer and the optical material during or after curing.
